(19) United States
(12) Patent Application Publication
(10) Pub. No.: US 2019/0246108 A1
(43) Pub. Date: Aug. 8, 2019

(54) ENTROPY DECODING APPARATUS, ENTROPY CODING APPARATUS, IMAGE DECODING APPARATUS, AND IMAGE CODING APPARATUS

(71) Applicants: SHARP KABUSHIKI KAISHA, Sakai City, Osaka (JP); FG Innovation Company Limited, Tuen Mun, New Territories (HK)

(72) Inventors: TOMOKO AONO, Sakai City (JP); YUKINOBU YASUGI, Sakai City, Osaka (JP); TOMOHIRO IKAI, Sakai City (JP)

(21) Appl. No.: 16/341,918

(22) PCT Filed: Aug. 23, 2017
(86) PCT No.: PCT/JP2017/030055

§ 371 Date: Apr. 14, 2019

(30) Foreign Application Priority Data
Oct. 14, 2016 (JP) 2016-202710

(51) Int. Cl. H04N 19/13; H04N 19/11; H04N 19/159; H04N 19/46; H04N 19/176; H04N 19/169

(52) U.S. Cl. CPC H04N 19/13; H04N 19/11; H04N 19/1887; H04N 19/46; H04N 19/176; H04N 19/159

(57) ABSTRACT

To improve the coding efficiency of intra-frame prediction of CU obtained by picture split. The present disclosure varies, based on the type of intra-frame prediction mode and/or the frequency of occurrence, the method of deriving a list used in estimation of the intra-frame prediction mode, and the binarization method in a case of entropy coding the intra-frame prediction mode.

### TECHNICAL FIELD

The embodiments of the present invention relate to an entropy decoding apparatus, an entropy coding apparatus, an image decoding apparatus, and an image coding apparatus.

### BACKGROUND ART

An image coding apparatus which generates coded data by coding a video and an image decoding apparatus which generates decoded images by decoding the coded data are used to transmit and record a video efficiently.

For example, specific video coding schemes include methods suggested by H.264/AVC and High-Efficiency Video Coding (HEVC).

In such a video coding scheme, images (pictures) constituting a video is managed by a hierarchy structure including slices obtained by splitting images, units of coding (also referred to as coding unit (CUs)) obtained by splitting slices, prediction units (PUs) which are blocks obtained by splitting coding units, and transform units (TUs), and are coded/decoded for each CU.

In such a video coding scheme, usually, a prediction image is generated based on local decoded images obtained by coding/decoding input images, and prediction residual (also referred to as “difference images” or “residual images”) obtained by subtracting prediction images from input images (original image) are coded. Generation methods of prediction images include an inter-screen prediction (an inter prediction) and an intra-screen prediction (intra prediction).

An example of a technique of recent video coding and decoding is described in NPL 1.

Furthermore, in late years, as a split scheme of Coding Tree Units (CTUs) constituting a slice, BT split to binary tree split CTUs is introduced in addition to QT split to quad tree split CTUs. This BT split includes horizontal split and vertical split.

As above, by QTBT split to perform BT split in addition to QT split, types of CU shapes largely increase than before. Therefore, various block shapes and combinations different from those in related art are possible, and this increases types of intra prediction modes and causes different occurrence frequencies from that in related art.

### CITATION LIST

### Non Patent Literature

NPL 1: * Algorithm Description of Joint Exploration Test Model 2 *, JVET-B1002, Joint Video Exploration Team (JVET) of ITU-T SG 16 WP 3 and ISO/IEC JTC 1/SC 29/WG 11, 20-26 February 2016

### SUMMARY OF INVENTION

### Technical Problem

In QTBT split, CUs of various shapes (aspect ratio) such as square, vertically long (1:2, 1:4, 1:8, and the like) and horizontally long (2:1, 4:1, 8:1, and the like) can occur. In addition, intra prediction modes used for a prediction of CUs also increase from 34 types of HEVC to 67 types. Along this, occurrence frequency of each intra prediction mode is also different than before; however, estimation of intra prediction modes and entropy coding have not been yet considered enough, and there is room for the improvement on coding efficiency. Considering occurrence frequency of prediction mode mores in derivation methods of lists used for estimation of intra prediction modes and binarization in entropy coding/decoding intra prediction modes, code amounts necessary for coding of intra prediction modes can be reduced.

Thus, one aspect of the invention has an object to improve coding efficiency than before by reducing code amounts of intra prediction modes.

### Solution to Problem

The entropy coding apparatus according to one aspect of the present invention is an entropy coding apparatus for entropy coding an intra prediction mode used for an intra prediction of a target block. The intra prediction mode is classified in a first intra prediction mode using a variable length code and a second intra prediction mode using a fixed length code. The entropy coding apparatus further includes: a coding means configured to code a flag to indicate whether a target intra prediction mode is the first intra prediction mode or the second intra prediction mode; a coding means configured to code in the first intra prediction mode to either code the first prediction mode, or code the first prediction mode after having coded a prefix, and a fixed length coding means configured to fixed length code the second intra prediction mode.

The entropy decoding apparatus according to one aspect of the present invention is an entropy decoding apparatus for entropy decoding an intra prediction mode used for an intra prediction of a target block. The intra prediction mode is classified in a first intra prediction mode using a variable length code and a second intra prediction mode using a fixed length code. The entropy decoding apparatus further includes: a decoding means configured to decode a flag to indicate whether a target intra prediction mode is the first intra prediction mode or the second intra prediction mode, a decoding means configured to decode in the first intra prediction mode to either decode the first prediction mode without decoding a prefix, or decode the first prediction mode after having decoded the prefix; and a fixed length decoding means configured to fixed length decode the second intra prediction mode.

### Advantageous Effects of Invention

According to each aspect according to the present invention, coding efficiency of the intra prediction of CUs obtained by split of pictures such as QTBT split can be improved than before.

### BRIEF DESCRIPTION OF DRAWINGS

FIG. 1 is a schematic diagram illustrating a configuration of an image transmission system according to Embodiment 1.

FIGS. 2A to 2F are diagrams illustrating a hierarchy structure of data of a coding stream according to Embodiment 1.

FIGS. 3A to 3H are diagrams illustrating patterns of PU split modes. FIGS. 3A to 3H indicate partition shapes in cases that PU split modes are 2N×2N, 2N×N, 2N×nU, 2N×nD, N×2N, nL×2N, nR×2N, and N×N, respectively.

FIGS. 4A and 4B are conceptual diagrams illustrating an example of reference pictures and reference picture lists.

FIG. 5 is a block diagram illustrating a configuration of an image decoding apparatus according to Embodiment 1.

FIG. 6 is a block diagram illustrating a configuration of an image coding apparatus according to Embodiment 1.

FIG. 7 is a schematic diagram illustrating a configuration of an inter prediction image generation unit of the image coding apparatus according to Embodiment 1.

FIGS. 8A and 88 are diagrams illustrating configurations of a transmitting apparatus equipped with the image coding apparatus and a receiving apparatus equipped with the image decoding apparatus according to Embodiment 1. FIG. 8A illustrates the transmitting apparatus equipped with the image coding apparatus, and FIG. 8B illustrates the receiving apparatus equipped with the image decoding apparatus.

FIGS. 9A and 9B are diagrams illustrating configurations of a recording apparatus equipped with the image coding apparatus and a regeneration apparatus equipped with the image decoding apparatus according to Embodiment 1. FIG. 9A illustrates the recording apparatus equipped with the image coding apparatus, and FIG. 9B illustrates the regeneration apparatus equipped with the image decoding apparatus.

FIG. 10 is a schematic diagram illustrating shapes of CUs obtained by QTBT split according to Embodiment 1.

FIG. 11 is a flowchart illustrating an operation of a prediction parameter decoding unit of the image decoding apparatus illustrated in FIG. 5.

FIG. 12 is a schematic diagram illustrating types (mode numbers) of intra prediction modes used in a step included in the operation of the prediction parameter decoding unit illustrated in FIG. 11.

FIG. 13 is a schematic diagram illustrating syntax of a CU used by the prediction parameter decoding unit of the image decoding apparatus illustrated in FIG. 5.

FIG. 14 is a schematic diagram illustrating an intra prediction parameter in the syntax of the CU illustrated in FIG. 13.

FIG. 15 is a schematic diagram illustrating a configuration of an intra prediction parameter coding unit of a prediction parameter coding unit of the image coding apparatus illustrated in FIG. 6.

FIG. 16 is a schematic diagram illustrating a configuration of an intra prediction parameter decoding unit of the prediction parameter decoding unit of the image decoding apparatus illustrated in FIG. 5.

FIG. 17 is a schematic diagram illustrating an order of a prediction mode in a case that an MPM candidate list derivation unit adds to an MPM candidate list in the intra prediction parameter coding unit illustrated in FIG. 15, and in the intra prediction parameter decoding unit illustrated in FIG. 16.

FIG. 18 a flowchart illustrating an operation that the MPM candidate list derivation unit derives the MPM candidate list in the intra prediction parameter coding unit illustrated in FIG. 15, and in the intra prediction parameter decoding unit illustrated in FIG. 16.

FIGS. 19A and 19B are flowcharts illustrating details of a step of the operation illustrated in FIG. 18.

FIGS. 20A and 20B are flowcharts illustrating details of a step of the operation illustrated in FIG. 18.

FIG. 21 is a flowchart illustrating details of a step of the operation illustrated in FIG. 18.

FIG. 22 is a code table in a case of categorizing the intra prediction modes into MPM, rem_selected_mode, and rem_non_selected_mode for coding.

FIG. 23 is a truncated rice (TR) code table.

FIG. 24 is a fixed length code table of a code length P bit.

FIG. 25 is an example of a variable length code table.

FIG. 26 is a graph representing proportions that MPM occupies in intra prediction modes.

FIG. 27 is an example of a code table of Embodiment 1 of the present application.

FIG. 28 is a flowchart indicating an example of a creation method of a smode list.

FIG 29 is a list in a case of categorizing intra prediction modes into smode and rem_selected_mode.

FIG. 30 is a code table of a prefix.

FIG. 31 is a flowchart indicating details of a step of an operation illustrated in Embodiment 1 of the present application.

FIG. 32 is an example of a code table of Embodiment 2 of the present application.

FIG. 33 is a flowchart indicating details of a step of an operation illustrated in Embodiment 2 of the present application.

FIG. 34 is an example of a code table of Embodiment 3 of the present application.

FIG. 35 is an example of a variable length code table used in Embodiment 3 of the present application.

FIG. 36 is another example of a variable length code table used in Embodiment 3 of the present application.

FIG. 37 is a flowchart indicating details of a step of an operation illustrated in Embodiment 3 of the present application.

FIGS. 38A and 38B are tables comparing expected values of code lengths in a case of using a conventional method and code lengths in a case of using Embodiment 3 of the present application.

FIG. 39 is a graph representing proportions that REM occupies in intra prediction modes.

FIG. 40 is a flowchart indicating details of a step of an operation illustrated in Embodiment 4 of the present application.

FIG. 41 is a list associating intra prediction modes with rem_selected_mode and rem_non_selected_mode based on distances with MPM.

FIG. 42 is a smode list and a rem_selected_mode list of Embodiment 4 of the present application.

FIG. 43 is an example of a code table of Embodiment 4 of the present application.

FIG. 44 is a smode list and a rem_selected_mode list of Embodiment 5 of the present application.

FIG. 45 is another smode list of Embodiment 5 of the present application.

FIG. 46 is a flowchart indicating details of a step of an operation illustrated in Embodiment 5 of the present application.

FIG. 47 is a schematic diagram indicating types (mode numbers) of the intra prediction mode used in Embodiment 6 of the present application.

FIG. 48 is an example of a code table of Embodiment 6 of the present application.

FIG. 49 is a flowchart indicating details of a step of an operation illustrated in Embodiment 6 of the present application.

FIG. 50 is a flowchart indicating details of a step of another operation illustrated in Embodiment 6 of the present application.

FIG. 51 is a schematic diagram illustrating a configuration of an intra prediction parameter coding unit of a prediction parameter coding unit of the image coding apparatus illustrated in FIG. 6.

FIG. 52 is a schematic diagram illustrating a configuration of an intra prediction parameter decoding unit of a prediction parameter decoding unit of the image decoding apparatus illustrated in FIG. 5.

FIG. 53 is a flowchart indicating details of reading ahead the coded data of the entropy decoding unit illustrated in FIG. 16.

FIG. 54 is an example indicating a correspondence of rem_selected_mode, rem_non_selected_mode, and RemIntraPredMode of the present application.

FIG. 55 is an example indicating relationships between the MPM candidate, RemIntraPredMode, rem_selected_mode, and rem_non_selected_mode of the present application.

FIG. 56 is an example describing a derivation method of the prediction mode list of chrominance of the present application.

### DESCRIPTION OF EMBODIMENTS

### Embodiment 1

Hereinafter, embodiments of the present invention are described with reference to the drawings.

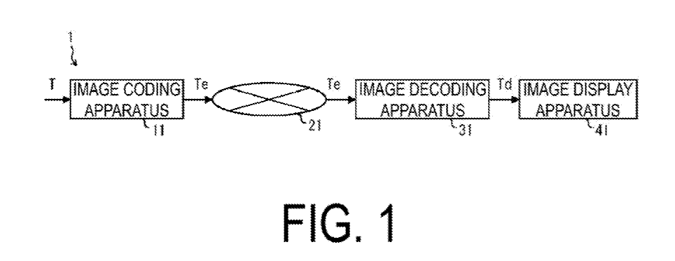

FIG. 1 is a schematic diagram illustrating a configuration of an image transmission system 1 according to the present embodiment.

The image transmission system 1 is a system configured to transmit codes of a coding target image having been coded, decode the transmitted codes, and display an image. The image transmission system 1 is configured to include an image coding apparatus 11, a network 21, an image decoding apparatus 31, and an image display apparatus 41.

An image T indicating an image of a single layer or multiple layers is input to the image coding apparatus 11. A layer is a concept used to distinguish multiple pictures in a case that there are one or more pictures to configure a certain time. For example, coding an identical picture in multiple layers having different image qualities and resolutions is scalable coding, and coding pictures having different viewpoints in multiple layers is view scalable coding. In a case of performing a prediction (an inter-layer prediction, an inter-view prediction) between pictures in multiple layers, coding efficiency greatly improves. In a case of not performing a prediction, in a case of (simulcast), coded data can be compiled.

The network 21 transmits a coding stream Te generated by the image coding apparatus 11 to the image decoding apparatus 31. Hie network 21 is the Internet, Wide Area Network (WAN), Local Area Network (LAN), or combinations thereof. The Network 21 is not necessarily a bidirectional communication network, but may be a unidirectional communication network configured to transmit broadcast wave such as digital terrestrial television broadcasting and satellite broadcasting. The network 21 may be substituted by a storage medium that records the coding stream Te, such as Digital Versatile Disc (DVD) and Blue-ray Disc (BD).

The image decoding apparatus 31 decodes each of the coding streams Te transmitted by the network 21, and generates one or multiple decoded images Td.

The image display apparatus 41 displays all or part of one or multiple decoded images Td generated by the image decoding apparatus 31. For example, the image display apparatus 41 includes a display device such as a liquid crystal display and an organic Electro-luminescence (EL) display. In spacial scalable coding and SNR scalable coding, in a case that the image decoding apparatus 31 and the image display apparatus 41 have high processing capability, an enhanced layer image having high image quality is displayed, and in a case of having lower processing capability, a base layer image which does not require as high processing capability and display capability as an enhanced layer is displayed.

### Operator

Operators used herein will be described below.

» is a right bit shift, « is a left bit shift, & is a bitwise AND, | is bitwise OR, and |= is a sum operation (OR) with another condition.

x ? y: z is a ternary operator to take y in a case that x is true (other than 0), and take z in a case that x is false (0).

Clip3 (a, b, c) is a function to clip c in a value equal to or greater than a and equal to or less than b, and a function to return a in a case that c is less than a (c<a), return b in a case that c is greater than b (c>b), and return c otherwise (however, a is equal to or less than b (a<=b)).

### Structure of Coding Stream Te

Prior to the detailed description of the image coding apparatus 11 and the image decoding apparatus 31 according to the present embodiment, the data structure of the coding stream Te generated by the image coding apparatus 11 and decoded by the image decoding apparatus 31 will be described.

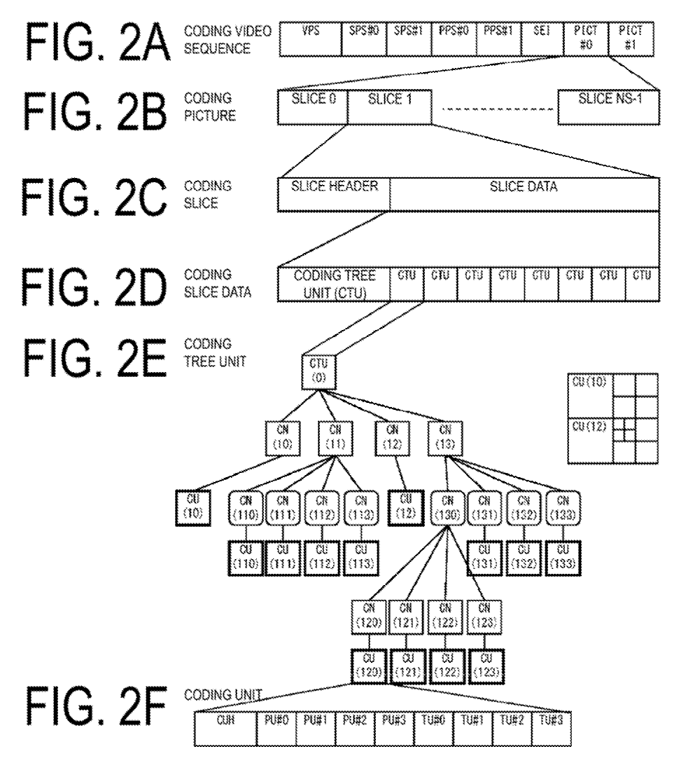

FIGS. 2A to 2F are diagrams illustrating the hierarchy structure of data in the coding stream Te. The coding stream Te includes a sequence and multiple pictures constituting a sequence illustratively. FIGS. 2A to 2F are diagrams indicating a coding video sequence prescribing a sequence SEQ, a coding picture prescribing a picture PICT, a coding slice prescribing a slice S, a coding slice data prescribing slice data, a coding tree unit included in coding slice data, and coding units (CUs) included in a coding tree unit, respectively.

### Coding Video Sequence

In the coding video sequence, a set of data referred to by the image decoding apparatus 31 to decode the sequence SEQ of a processing target is prescribed. As illustrated in FIG. 2A, the sequence SEQ includes a Video Parameter Set, a Sequence Parameter Set SPS, a Picture Parameter Set PPS, a picture PICT, and a Supplemental Enhancement Information SEI. Here, a value indicated after # indicates a layer ID. In FIGS. 2A to 2F, although an example is illustrated where coded data of #0 and #1, in other words, layer 0 and layer 1 exists, types of layers and the number of layers do not depend on this.

In the Video Parameter Set VPS, in a video constituted by multiple layers, a set of coding parameters common to multiple videos and a set of coding parameters associated with multiple layers and art individual layer included in a video are prescribed.

In the Sequence Parameter Set SPS, a set of coding parameters referred to by the image decoding apparatus 31 to decode a target sequence is prescribed. For example, width and height of a picture are prescribed. Note that multiple SPSs may exist. In that case, any of multiple SPSs is selected from the PPS.

In the Picture Parameter Set PPS, a set of coding parameters referred to by the image decoding apparatus 31 to decode each picture in a target sequence is prescribed. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each picture in a target sequence.

### Coding Picture

In the coding picture, a set of data referred to by the image decoding apparatus 31 to decode the picture PICT of a processing target is prescribed. As illustrated in FIG. 2B, the picture PICT includes slices S0 to S_{NS-1} (NS is the total number of slices included in the picture PICT).

Note that in a case that it is not necessary to distinguish the slices S0 to S_{NS-1} below, subscripts of reference signs may be omitted and described. The same applies to data included in the coding stream Te described below and described with an added subscript.

### Coding Slice

In the coding slice, a set of data referred to by the image decoding apparatus 31 to decode the slice S of a processing target is prescribed. As illustrated in FIG. 2C, the slice S includes a slice header SH and a slice data SDATA.

The slice header SH includes a coding parameter group referred to by the image decoding apparatus 31 to determine a decoding method of a target slice. Slice type specification information (slice_type) to specify a slice type is one example of a coding parameter included in the slice header SH.

Examples of slice types that can be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like.

Note that, the slice header SH may include a reference (pic_parameter_set_id) to the Picture Parameter Set PPS included in the coding video sequence.

### Coding Slice Data

In the coding slice data, a set of data referred to by the image decoding apparatus 31 to decode the slice data SDATA of a processing target is prescribed. As illustrated in FIG. 2D, the slice data SDATA includes Coding Tree Units (CTUs). The CTU is a fixed size (for example, 64×64) rectangle constituting a slice, and may be referred to as a Largest Coding Unit (LCU).

### Coding Tree Unit

As illustrated in FIG. 2E, a set of data referred to by the image decoding apparatus 31 to decode a coding tree unit of a processing target is prescribed. The coding tree unit is split by recursive quad tree splits (QT splits) or binary tree splits (BT splits). Nodes of a tree structure obtained by recursive quad tree splits or binary tree splits are referred to as Coding Nodes (CN). Intermediate nodes of quad trees and binary trees are a Coding Tree (CT), and the coding tree unit itself is also prescribed as the highest layer of Coding Tree.

The CTU includes a QT split flag (cu_split_flag) indicating whether or not to perform a QT split and a BT split mode (split_bt_mode) indicating a split method of a BT split. In a case that cu_split_flag is 1, the CTU is split into four coding node CNs. In a case that cu_split_flag is 0, the coding node CN is not split, and has one Coding Unit (CU) as a node. On the other hand, in a case that split_bt_mode is 2, the CTU is split horizontally into two coding nodes CNs. In a case that split_bt_mode is 1, the CN is split vertically into two coding nodes CNs. In a case that split_bt_mode is 0, the coding node CN is not split, and has one coding unit CU as a node. The coding unit CU is an end node of the coding tree, and is not split anymore. The coding unit CU is a basic unit of coding processing.

For example, a size of the coding unit which can be taken in a case that a size of the coding tree unit CTU is 64×64 pixels is any of 64×64 pixels, 64×32 pixels, 32×64 pixels, 32×32 pixels, 64×16 pixels, 16×64 pixels, 32×16 pixels, 16×32 pixels, 16×16 pixels, 64×8 pixels, 8×64 pixels, 32×8 pixels, 8×32 pixels, 16×8 pixels, 8×16 pixels, and 8×8 pixels. However, depending on the number of times and combinations of splits, a constraint related to a size of the coding unit, and the like, a size other than this can be also taken.

### Coding Unit

As illustrated in FIG. 2F, a set of data referred to by the image decoding apparatus 31 to decode the coding unit of a processing target is prescribed. Specifically, the coding unit is constituted by a prediction tree, a transform tree, and a CU header CUH. In the CU header, a prediction mode, a split method (PU split mode), and the like are prescribed.

In the prediction tree, prediction information (a reference picture index, a motion vector, and the like) of each prediction unit (PU) where the coding unit is split into one or multiple is prescribed. In another expression, the prediction unit is one or multiple non-overlapping regions constituting the coding unit. The prediction tree includes one or multiple prediction units obtained by the above-mentioned split. Note that, in the following, a unit of prediction where the prediction unit is further split is referred to as a “subblock”. The subblock is constituted by multiple pixels. In a case that sizes of the prediction unit and the subblock is same, there is one subblock in the prediction unit. In a case that the prediction unit is larger than a size of the subblock, the prediction unit is split into subblocks. For example, in a case that the prediction unit is 8×8, and the subblock is 4×4, the prediction unit is split into four subblocks formed by two horizontal splits and two perpendicular splits.

The prediction processing may be performed for each one of this prediction unit (subblock).

Generally speaking, there are two types of split in the prediction tree including a case of an intra prediction and a case of an inter prediction. The intra prediction is a prediction in an identical picture, and the inter prediction refers to a prediction processing performed between mutually different pictures (for example, between display times, and between layer images).

In a case of an intra prediction, the split method has 2N×2N (the same size as the coding unit) and N×N.

In a case of an inter prediction, the split method includes coding by a PU split mode (part_mode) of the coded data, and includes 2N×2N (the same size as the coding unit), 2N×N, 2N×nU, 2N×nD, N×2N, nL×2N, nR×2N and N×N, and the like. Note that 2N×N and N×2N indicate a symmetric split of 1:1, and 2N×nU, 2N×nD and nL×2N, nR×2N indicate an asymmetry split of 1:3 and 3:1. The PUs included in the CU are expressed as PU0, PU1, PU2, and PU3 sequentially.

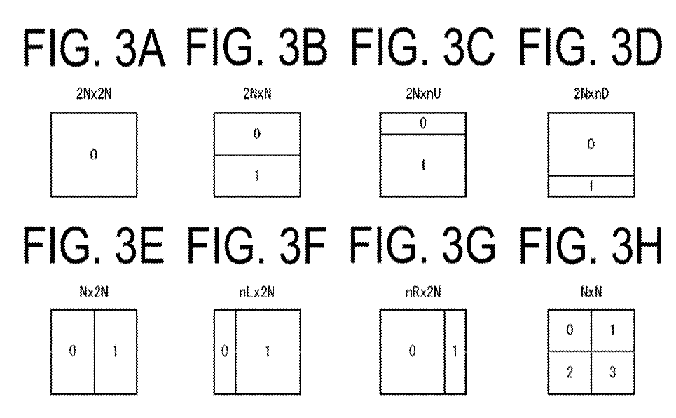

FIGS. 3A to 3H illustrate shapes of partitions in respective PU split modes (positions of boundaries of PU splits) specifically. FIG. 3A indicates a partition of 2N×2N, and FIGS. 3B, 3C, and 3D indicate partitions (horizontally long partitions) of 2N×N, 2N×nU, and 2N×nD, respectively. FIGS. 3E, 3F, and 3G indicate partitions (vertically long partitions) in cases of N×2N, nL×2N, and nR×2N, respectively, and FIG. 3H indicates a partition of N×N. Note that horizontally long partitions and vertically long partitions are collectively referred to as rectangular partitions, and 2N×2N and N×N are collectively referred to as square partitions.

In the transform tree, the coding unit is split into one or multiple transform units, and a position and a size of each transform unit are prescribed. In another expression, the transform unit is one or multiple non-overlapping regions constituting the coding unit. The transform tree includes one or multiple transform units obtained by the above-mentioned split.

Splits in the transform tree include those to allocate a region that is the same size as the coding unit as a transform unit, and those by recursive quad tree partitioning similar to the above-mentioned splits of CUs.

A transform processing is performed for each transform unit.

### Prediction Parameter

A prediction image of Prediction Units (PUs) is derived by prediction parameters attached to the PUs. The prediction parameter includes a prediction parameter of an intra prediction or a prediction parameter of an inter prediction. The prediction parameter of an inter prediction (inter prediction parameters) will be described below. The inter prediction parameter is constituted by prediction list utilization flags predFlagL0 and predFlagL1, reference picture indexes refIdxL0 and refIdxL1, and motion vectors mvL0 and mvL1. The prediction list utilization flags predFlagL0 and predFlagL1 are flags to indicate whether or not reference picture lists referred to as L0 list and L1 list respectively are used, and a corresponding reference picture list is used in a case that the value is 1. Note that, in a case that the present specification mentions “a flag indicating whether or not XX”, a flag being other than 0 (for example, 1) assumes a case of XX, and a flag being 0 assumes a case of not XX, and 1 is treated as true and 0 is treated as false in a logical negation, a logical product, and the like (hereinafter, the same is applied). However, other values can be used for true values and false values in real apparatuses and methods.

For example, syntax elements to derive inter prediction parameters included in a coded data include a PU split mode part_mode, a merge flag merge_flag, a merge index merge_idx, an inter prediction indicator inter_pred_idc, a reference picture index refIdxLX, a prediction vector index mvp_LX_idx, and a difference vector mvdLX.

### Reference Picture List

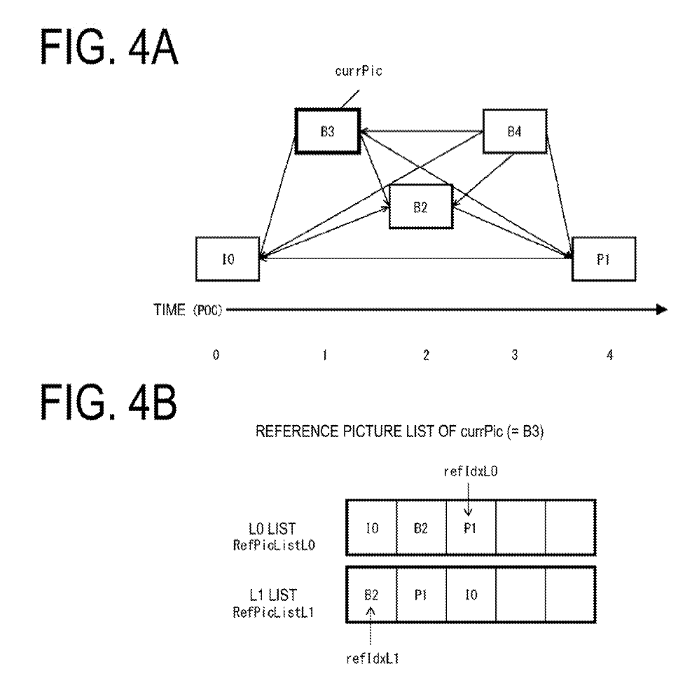

A reference picture list is a list constituted by reference pictures stored in a reference picture memory 306. FIGS. 4A and 4B are conceptual diagrams illustrating an example of reference pictures and reference picture lists. In FIG. 4A, a rectangle indicates a picture, an arrow indicates a reference relationship of a picture, a horizontal axis indicates time, each of I, P, and B in a rectangle indicates an intra-picture, a uni-prediction picture, a bi-prediction picture, and a number in a rectangle indicates a decoding order. As illustrated, the decoding order of the pictures is I0, P1, B2, B3, and B4, and the display order is I0, B3, B2, B4, and P1. FIG. 4B indicates an example of reference picture lists. The reference picture list is a list to represent a candidate of a reference picture, and one picture (slice) may include one or more reference picture lists. In the illustrated example, a target picture B3 includes two reference picture lists, i.e., a L0 list RefPicList0 and a L1 list RefPicList1. In a case that a target picture is B3, the reference pictures are I0, P1, and B2, the reference picture includes these pictures as elements. For an individual prediction unit, which picture in a reference picture list RefPicListX is actually referred to is specified with a reference picture index refIdxLX. The diagram indicates an example where reference pictures P1 and B2 are referred to by refIdxL0 and refIdxL1.

### Merge Prediction and AMVP Prediction

Decoding (coding) methods of prediction parameters include a merge prediction (merge) mode and an Adaptive Motion Vector Prediction (AMVP) mode, and merge flag merge_flag is a flag to identify these. The merge prediction mode is a mode to use to derive from prediction parameters of neighboring PUs already processed without including a prediction list utilization flag predFlagLX (or an inter prediction indicator inter_pred_idc), a reference picture index refIdxLX, and a motion vector mvLX in a coded data, and the AMVP mode is a mode to include an inter prediction indicator inter_pred_idc, a reference picture index refIdxLX, a motion vector mvLX in a coded data. Note that, the motion vector mvLX is coded as a prediction vector index mvp_LX_idx identifying a prediction vector mvpLX and a difference vector mvdLX.

The inter prediction indicator inter_pred_idc is a value indicating types and the number of reference pictures, and takes any value of PRED_L0, PRED_L1, and PRED_BI. PRED_L0 and PRED_L1 indicate to uses reference pictures managed in the reference picture list of the L0 list and the L1 list respectively, and indicate to use one reference picture (uni-prediction). PRED_BI indicates to use two reference pictures (bi-prediction BiPred), and use reference pictures managed in the L0 list and the L1 list. The prediction vector index mvp_LX_idx is an index indicating a prediction vector, and the reference picture index refIdxLX is an index indicating reference pictures managed in a reference picture list. Note that LX is a description method used in a case of not distinguishing the L0 prediction and the L1 prediction, and distinguishes parameters for the L0 list and parameters for the L1 list by replacing LX with L0 and L1.

The merge index merge_idx is an index to indicate to use either prediction parameter as a prediction parameter of a decoding target PU among prediction parameter candidates (merge candidates) derived from PUs of which the processing is completed.

### Motion Vector

The motion vector mvLX indicates a gap quantity between blocks in two different pictures. A prediction vector and a difference vector related to the motion vector mvLX is referred to as a prediction vector mvpLX and a difference vector mvdLX respectively.

Inter Prediction indicator inter_pred_idc and Prediction List Utilization Flag predFlagLX

A relationship between an inter prediction indicator inter_pred_idc and prediction list utilization flags predFlagL0 and predFlagL1 are as follows, and those can be converted mutually.

inter_pred_idc (predFlagL1<<1)+predFlagL0

predFlagL0=inter_pred_idc & 1

predFlagL1=inter_pred_idc>>1

Note that an inter prediction parameter may use a prediction list utilization flag or may use an inter prediction indicator. A determination using a prediction list utilization flag may be replaced with a determination using an inter prediction indicator. On the contrary, a determination using an inter prediction indicator may be replaced with a determination using a prediction list utilization flag.

Determination of Bi-Prediction biPred

A flag biPred of whether or not a bi-prediction BiPred can be derived from whether or not two prediction list utilization flags are both 1. For example, the flag can be derived by the following equation.

biPred=(predFlagL0==1 && predFlagL1==1)

The flag biPred can be also derived from whether an inter prediction indicator is a value indicating to use two prediction lists (reference pictures). For example, the flag can be derived by the following equation.

biPred=(inter_pred_idc==PRED_BI)? 1:0

The equation can be also expressed with the following equation.

biPred=(inter_pred_idc==PRED_BI)

Note that, for example, PRED_BI can use the value of 3.

### Configuration of Image Decoding Apparatus

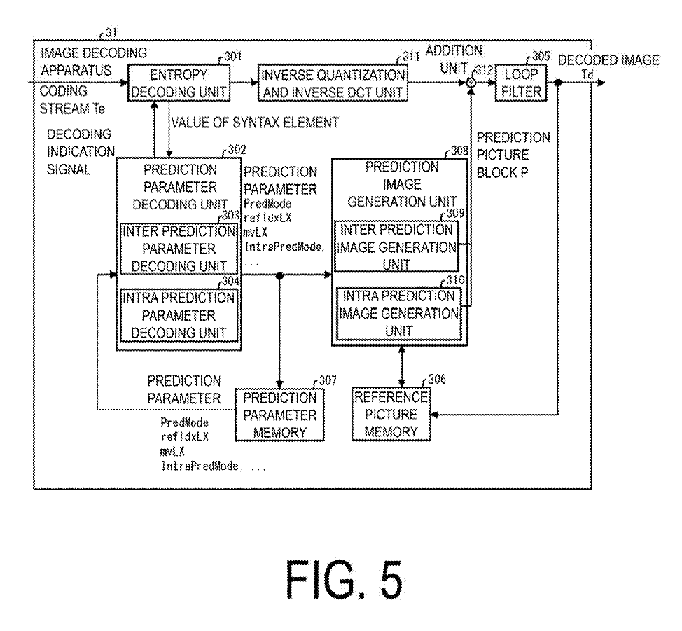

A configuration of the image decoding apparatus 31 according to the present embodiment will now be described. FIG. 5 is a block diagram illustrating a configuration of the image decoding apparatus 31 according to the present embodiment. The image decoding apparatus 31 is configured to include an entropy decoding unit 301, a prediction parameter decoding unit (a prediction image decoding apparatus) 302, a loop filter 305, a reference picture memory 306, a prediction parameter memory 307, a prediction image generation unit (prediction image generation apparatus) 308, an inverse quantization and inverse DCT unit 311, and an addition unit 312.

The prediction parameter decoding unit 302 is configured to include an inter prediction parameter decoding unit 303 and an intra prediction parameter decoding unit 304. The prediction image generation unit 308 is configured to include an inter prediction image generation unit 309 and an intra prediction image generation unit 310.

The entropy decoding unit 301 performs entropy decoding on the coding stream Te input from the outside, and separates and decodes individual codes (syntax elements). Separated codes include prediction information to generate a prediction image and residual information to generate a difference image and the like.

The entropy decoding unit 301 outputs a part of the separated codes to the prediction parameter decoding unit 302. For example, a part of the separated codes includes a prediction mode predMode, a PU split mode part_mode, a merge flag merge_flag, a merge index merge_idx, an inter prediction indicator inter_pred_idc, a reference picture index refIdxLX, a prediction vector index mvp_LX_idx, and a difference vector mvdLX. The control of which code to decode is performed based on an indication of the prediction parameter decoding unit 302. The entropy decoding unit 301 outputs quantization coefficients to the inverse quantization and inverse DCT unit 311. These quantization coefficients are coefficients obtained by performing Discrete Cosine Transform (DCT) on residual signal to quantize in coding process.

The inter prediction parameter decoding unit 303 decodes an inter prediction parameter with reference to a prediction parameter stored in the prediction parameter memory 307 based on a code input from the entropy decoding unit 301.

The inter prediction parameter decoding unit 303 outputs a decoded inter prediction parameter to the prediction image generation unit 308, and also stores the decoded inter prediction parameter in the prediction parameter memory 307. Details of the inter prediction parameter decoding unit 303 will be described below.

The intra prediction parameter decoding unit 304 decodes an intra prediction parameter with reference to a prediction parameter stored in time prediction parameter memory 307 based on a code input from the entropy decoding unit 301. The intra prediction parameter is a parameter used in a processing to predict a CU in one picture, for example, an intra prediction mode IntraPredMode. The intra prediction parameter decoding unit 304 outputs a decoded intra prediction parameter to the prediction image generation unit 308, and also stores the decoded ultra prediction parameter in the prediction parameter memory 307.

The intra prediction parameter decoding unit 304 may derive different intra prediction modes for luminance and chrominance, in this case, the intra prediction parameter decoding unit 304 decodes a luminance prediction mode IntraPredModeY as a prediction parameter of luminance, and decodes a chrominance prediction mode IntraPredModeC as a prediction parameter of chrominance. The luminance prediction mode IntraPredModeY includes 35 modes, and corresponds to a planar prediction (0), a DC prediction (1), directional predictions (2 to 34). The chrominance prediction mode IntraPredModeC uses any of a planar prediction (0), a DC prediction (1), directional predictions (2 to 34), and a LM mode (35). The intra prediction parameter decoding unit 304 may decode a flag indicating whether IntraPredModeC is a mode that is the same as the luminance mode, assign IntraPredModeY to IntraPredModeC in a case of indicating that the flag is the mode that is the same as the luminance mode, and decode a planar prediction (0), a DC prediction (1), directional predictions (2 to 34), and a LM mode (35) as IntraPredModeC in a case of indicating that the flag is a mode different from the luminance mode.

The loop filter 305 applies a filter such as a deblocking filter, a sample adaptive offset (SAO), and an adaptive loop filter (ALF) on a decoded image of a CU generated by the addition unit 312.

The reference picture memory 306 stores a decoded image of a CU generated by the addition unit 312 in a prescribed position for each picture and CU of a decoding target.

The prediction parameter memory 307 stores a prediction parameter in a prescribed position for each picture and prediction unit for a subblock, a fixed size block, and a pixel) of a decoding target. Specifically, the prediction parameter memory 307 stores an inter prediction parameter decoded by the inter prediction parameter decoding unit 303, an intra prediction parameter decoded by the intra prediction parameter decoding unit 304 and a prediction mode predMode separated by the entropy decoding unit 301. For example, inter prediction parameters stored include a prediction list utilization flag predFlagLX (the inter prediction indicator inter_pred_idc), a reference picture index refIdxLX, and a motion vector mvLX.

To the prediction image generation unit 308, a prediction mode predMode input from the entropy decoding unit 301 is input, and a prediction parameter is input from the prediction parameter decoding unit 302. The prediction image generation unit 308 reads a reference picture from the reference picture memory 306. The prediction image generation unit 308 generates a prediction image of a PU using a prediction parameter input and a reference picture read with a prediction mode indicated by the prediction mode predMode.

Here, in a case that the prediction mode predMode indicates an inter prediction mode, the inter prediction image generation unit 309 generates a prediction image of a PU by an inter prediction using an inter prediction parameter input from the inter prediction parameter decoding unit 303 and a read reference picture.

For a reference picture list (a L0 list or a L1 list) where a prediction list utilization flag predFlagLX is 1, the inter prediction image generation unit 309 reads a reference picture block from the reference picture memory 306 in a position indicated by a motion vector based on a decoding target PU from reference pictures indicated by the reference picture index refIdxLX. The inter prediction image generation unit 309 performs a prediction based on a read reference picture block and generates a prediction image of a PU. The inter prediction image generation unit 309 outputs the generated prediction image of the PU to the addition unit 312.

In a case that the prediction mode predMode indicates an intra prediction mode, the intra prediction image generation unit 310 performs an intra prediction using an intra prediction parameter input from the intra prediction parameter decoding unit 304 and a read reference picture. Specifically, the intra prediction image generation unit 310 reads an adjacent PU, which is a picture of a decoding target, in a prescribed range from a decoding target PU among PUs already decoded, from the reference picture memory 306. The prescribed range is, for example, any of adjacent PUs of in left, top left, top, and top right in a case that a decoding target PU moves in order of so-called raster scan sequentially, and varies according to intra prediction modes. The order of the raster scan is an order to move sequentially from the left edge to the right edge in each picture for each row from the top edge to the bottom edge.

The intra prediction image generation unit 310 performs a prediction in a prediction mode indicated by the intra prediction mode IntraPredMode for a read adjacent PU, and generates a prediction image of a PU. The into prediction image generation unit 310 outputs the generated prediction image of the PU to the addition unit 312.

In a case that the intra prediction parameter decoding unit 304 derives different intra prediction modes with luminance and chrominance, the intra prediction image generation unit 310 generates a prediction image of a PU of luminance by any of a planar prediction (0), a DC prediction (1), and directional predictions (2 to 34) depending on a luminance prediction mode IntraPredModeY, and generates a prediction image of a PU of chrominance by any of a planar prediction (0), a DC prediction (1), directional predictions (2 to 34), and LM mode (35) depending on a chrominance prediction mode IntraPredModeC.

The inverse quantization and inverse DCT unit 311 inverse quantizes quantization coefficients input from the entropy decoding unit 301 and calculates DCT coefficients. The inverse quantization and inverse DCT unit 311 performs an Inverse Discrete Cosine Transform (an inverse DCT, an inverse discrete cosine transform) for the calculated DCT coefficients, and calculates a residual signal. The inverse quantization and inverse DCT unit 311 outputs the calculated residual signal to the addition unit 312.

The addition unit 312 adds a prediction image of a input from the inter prediction image generation unit 309 or the intra prediction image generation unit 310 and a residual signal input from the inverse quantization and inverse DCT unit 311 for every pixel, and generates a decoded image of a PU. The addition unit 312 stores the generated decoded image of a PU in the reference picture memory 306, and outputs a decoded image Td where the generated decoded image of the PU is integrated for every picture to the outside.

### Configuration of Image Coding Apparatus

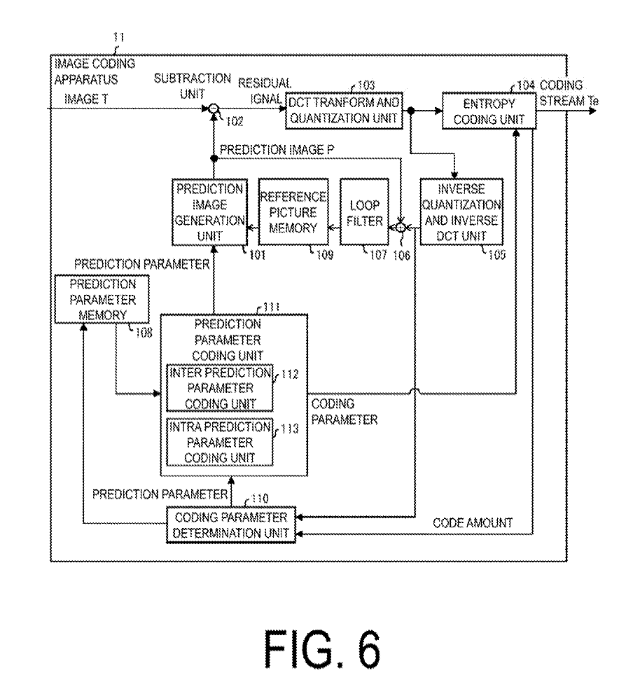

A configuration of the image coding apparatus 11 according to the present embodiment will now be described. FIG. 6 is a block diagram illustrating a configuration of the image coding apparatus 11 according to the present embodiment. The image coding apparatus 11 is configured to include a prediction image generation unit 101, a subtraction unit 102, a DCT and quantization unit 103, an entropy coding unit 104, an inverse quantization and inverse DCT unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, and a prediction parameter coding unit 111. The prediction parameter coding unit 111 is configured to include an inter prediction parameter coding unit 112 and an intra prediction parameter coding unit 113.

For each picture of an image T, the prediction image generation unit 101 generates a prediction image P of a prediction unit PU for each coding unit CU that is a region where the picture is split. Here, the prediction image generation unit 101 reads a block that has been decoded from the reference picture memory 109, based on a prediction parameter input from the prediction parameter coding unit 111. For example, in a case of an inter prediction, the prediction parameter input from the prediction parameter coding unit 111 is a motion vector. The prediction image generation unit 101 reads a block in a position in a reference image indicated by a motion vector starting from a target PU. In a case of an intra prediction, the prediction parameter is, for example, an intra prediction mode. The prediction image generation unit 101 reads a pixel value of an adjacent PU used in an intra prediction mode from the reference picture memory 109, and generates the prediction image P of a PU. The prediction image generation unit 101 generates the prediction image P of a PU using one prediction scheme among multiple prediction schemes for the read reference picture block. The prediction image generation unit 101 outputs the generated prediction image P of a PU to the subtraction unit 102.

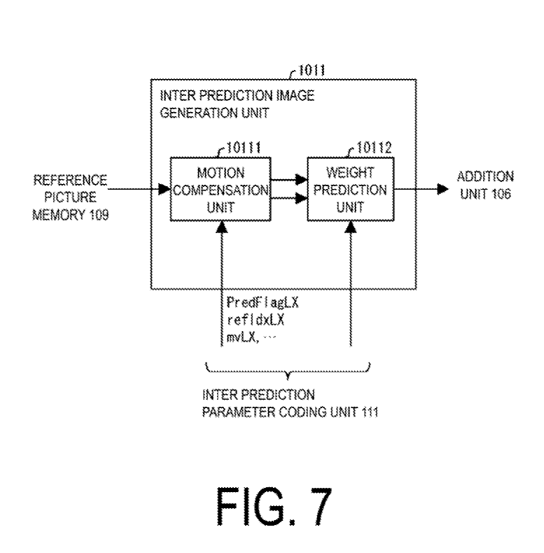

Note that the prediction image generation unit 101 is an operation that is the same as the prediction image generation unit 308 already described. For example, FIG. 7 is a schematic diagram illustrating a configuration of the inter prediction image generation unit 1011 included in the prediction image generation unit 101. The inter prediction image generation unit 1011 is configured to include a motion compensation unit 10111 and a weight prediction unit 10112. Descriptions about the motion compensation unit 10111 and the weight prediction unit 10112 are omitted since the motion compensation unit 10111 and the weight prediction unit 10112 have configurations similar to each of the above-mentioned motion compensation unit 3091 and weight prediction unit 3094, respectively.

The prediction image generation unit 101 generates the prediction image P of a PU based on a pixel value of a reference block read from the reference picture memory by using a parameter input by the prediction parameter coding unit. The prediction image generated by the prediction image generation unit 101 is output to the subtraction unit 102 and the addition unit 106.

The subtraction unit 102 subtracts a signal value of the prediction image P of a PU input from the prediction image generation unit 101 from a pixel value of a corresponding PU of the image T, and generates a residual signal. The subtraction unit 102 outputs the generated residual signal to the DCT and quantization unit 103.

The DCT and quantization unit 103 performs a DCT for the residual signal input from the subtraction unit 102, and calculates DCT coefficients. The DCT and quantization unit 103 quantizes the calculated DCT coefficients to calculate quantization coefficients. The DCT and quantization unit 103 outputs the calculated quantization coefficients to the entropy coding unit 104 and the inverse quantization and inverse DCT unit 105.

To the entropy coding unit 104, quantization coefficients are input from the DCT and quantization unit 103, and coding parameters are input from the prediction parameter coding unit 111. For example, input coding parameters include codes such as a reference picture index refIdxLX, a prediction vector index mvp_LX_idx, a difference vector mvdLX, a prediction mode predMode, and a merge index merge_idx.

The entropy coding unit 104 entropy codes the input quantization coefficients and coding parameters to generate the coding stream Te, and outputs the generated coding stream Te to the outside.

The inverse quantization and inverse DCT unit 105 inverse quantizes the quantization coefficients input from the DCT and quantization unit 103 to calculate DCT coefficients. The inverse quantization and inverse DCT unit 105 performs inverse DCT on the calculated DCT coefficient to calculate residual signals. The inverse quantization and inverse DCT unit 105 outputs the calculated residual signals to the addition unit 106.

The addition unit 106 adds signal values of the prediction image P of the PUs input from the prediction image generation unit 101 and signal values of the residual signals input from the inverse quantization and inverse DCT unit 105 for every pixel, and generates the decoded image. The addition unit 106 stores the generated decoded image in the reference picture memory 109.

The loop filter 107 performs a deblocking filter, a sample adaptive offset (SAO), and an adaptive loop filter (ALF) to the decoded image generated by the addition unit 106.

The prediction parameter memory 108 stores the prediction parameters generated by the coding parameter determination unit 110 for every picture and CU of the coding target in a prescribed position.

The reference picture memory 109 stores the decoded image generated by the loop filter 107 for every picture and CU of the coding target in a prescribed position.

The coding parameter determination unit 110 selects one set among multiple sets of coding parameters. A coding parameter is the above-mentioned prediction parameter or a parameter to be a target of coding generated associated with the prediction parameter. The prediction image generation unit 101 generates the prediction image P of the PUs using each of the sets of these coding parameters.

The coding parameter determination unit 110 calculates cost values indicating a volume of an information quantity and coding errors for each of the multiple sets. For example, a cost value is a sum of a code amount and a value of multiplying a coefficient λ by a square error. The code amount is an information quantity of the coding stream Te obtained by entropy coding a quantization error and a coding parameter. The square error is a sum total of pixels for square values of residual values of residual signals calculated in the subtraction unit 102. The coefficient λ is a real number that is larger than a pre-configured zero. The coding parameter determination unit 110 selects a set of coding parameters by which the calculated cost value is minimized. With this configuration, the entropy coding unit 104 outputs the selected set of coding parameters as the coding stream Te to the outside, and does not output sets of coding parameters that are not selected. The coding parameter determination unit 110 stores the determined coding parameters in the prediction parameter memory 108.

The prediction parameter coding unit 111 derives a format for coding from parameters input from the coding parameter determination unit 110, and outputs the format to the entropy coding unit 104. A derivation of a format for coding is, for example, to derive a difference vector from a motion vector and a prediction vector. The prediction parameter coding unit 111 derives parameters necessary to generate a prediction image from parameters input from the coding parameter determination unit 110, and outputs the parameters to the prediction image generation unit 101. For example, parameters necessary to generate a prediction image are a motion vector of a subblock unit.

The inter prediction parameter coding unit 112 derives inter prediction parameters such as a difference vector, based on prediction parameters input from the coding parameter determination unit 110. The inter prediction parameter coding unit 112 includes a partly identical configuration to a configuration by which the inter prediction parameter decoding unit 303 (see FIG. 6 and the like) derives inter prediction parameters, as a configuration to derive parameters necessary for generation of a prediction image output to the prediction image generation unit 101. A configuration of the inter prediction parameter coding unit 112 will be described below.

The intra prediction parameter coding unit 113 derives a format for coding (for example, mpm_idx, rem_intra_luma_pred_mode, and the like) from the intra prediction mode IntraPredMode input from the coding parameter determination unit 110.

### CU Shape Obtained by QTBT Split

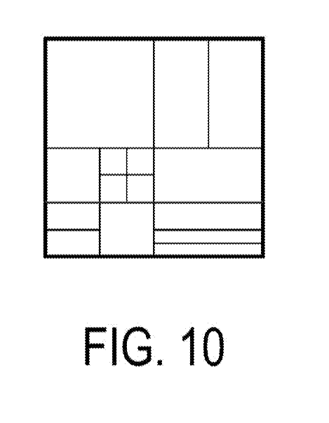

FIG. 10 is a schematic diagram illustrating shapes of CUs obtained by QTBT split according to the present embodiment. As illustrated in FIG. 10, vertically long/horizontally long/square CUs are obtained by a picture performed QT split, and further QT split or BT split.

Note that, although not specifically illustrated, attribute information such as a position or a dimension of a block during processing or a processed block (CU/PU/TU) is supplied to a required spot appropriately.

### Operation of Prediction Parameter Decoding Unit 302

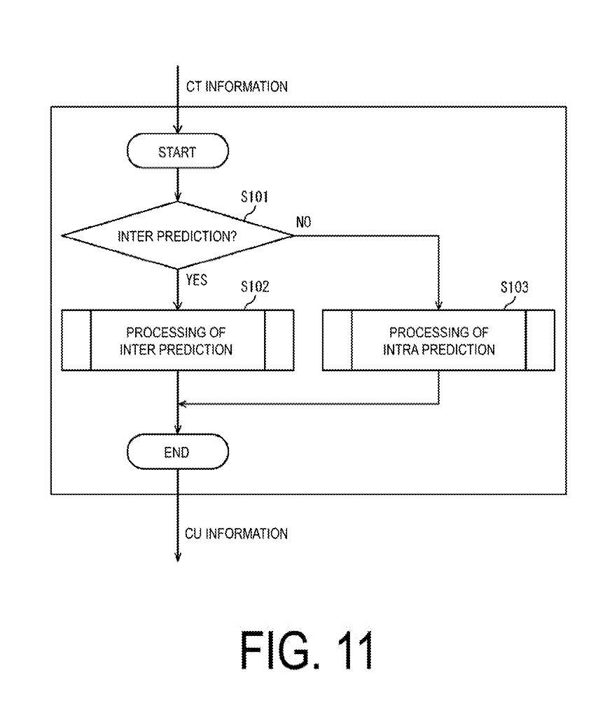

FIG. 11 is a flowchart illustrating an operation of the prediction parameter decoding unit 302 of the image decoding apparatus 31 illustrated in FIG. 5. The operation illustrated in FIG. 11 includes steps S101 to S103.

### Step S101

The prediction parameter decoding unit 302 receives CT information related to CTs, and determines whether or not to perform an inter prediction. In step S101, in a case of determining that the prediction parameter decoding unit 302 performs an inter prediction (YES), step S102 is performed. In step S101, in a case of determining that the prediction parameter decoding unit 302 does not perform an inter prediction (NO), step S103 is performed.

### Step S102

In the image decoding apparatus 31, processing of an inter prediction is performed. The prediction parameter decoding unit 302 supplies CU information related to CUs depending on processing results of the inter prediction to the prediction image generation unit 308 (FIG. 5).

### Step S103

In the image decoding apparatus 31, processing of an intra prediction is performed. The prediction parameter decoding unit 302 supplies CU information related to CUs depending on processing results of the intra prediction to the prediction image generation unit 308.

Note that the above-mentioned processing is applicable to not only decoding processing but also coding processing. In coding processing, the “image decoding apparatus 31”, the “prediction parameter decoding unit 302”, the “prediction image generation unit 308” illustrated in FIG. 5 correspond to the “image coding apparatus 11”, the “prediction parameter coding unit 111”, the “prediction image generation unit 101” illustrated in FIG. 6, respectively. Note that, in the following processing, each unit of the image decoding apparatus 31 illustrated in FIG. 5 can be associated with each unit of the image coding apparatus 11 illustrated in FIG. 6.

### Types of Intra Prediction Mode

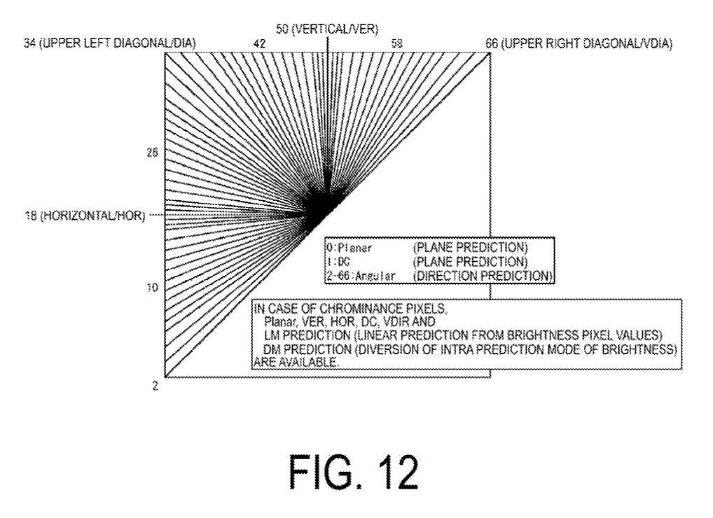

FIG. 12 is a schematic diagram illustrating types (mode numbers) of intra prediction modes used in step S103 included in the operation of the prediction parameter decoding unit 302 illustrated in FIG. 11. For example, as illustrated in FIG. 12, there are 67 types (0 to 66) of intra prediction modes.

### Syntax of CU and Intra Prediction Parameter

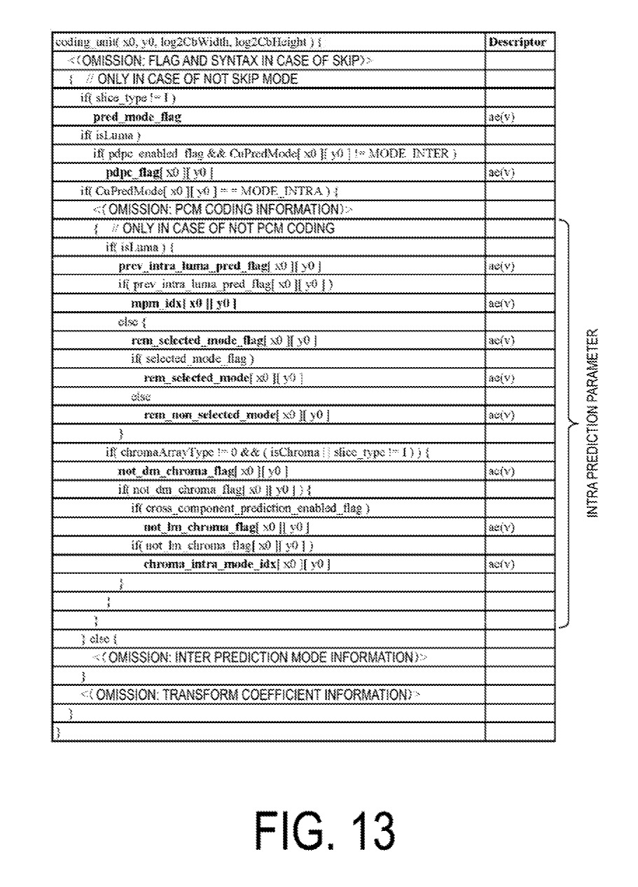

FIG. 13 is a schematic diagram illustrating syntax of a CU used by the prediction parameter decoding unit 302 of the image decoding apparatus 31 illustrated in FIG. 5. As illustrated in FIG. 13, the prediction parameter decoding unit 302 performs coding_unit function. The coding_unit function takes following arguments.

x0: X coordinate of the top left luminance pixel of the target CU

y0: Y coordinate of the top left luminance pixel of the target CU

log 2CbWidth: Width of the target CU (length of the X direction)

log 2CbHeight: Height of the target CU (length of the Y direction)

Note that logarithmic values of 2 are used for width and height of the target CU but not limited to this.

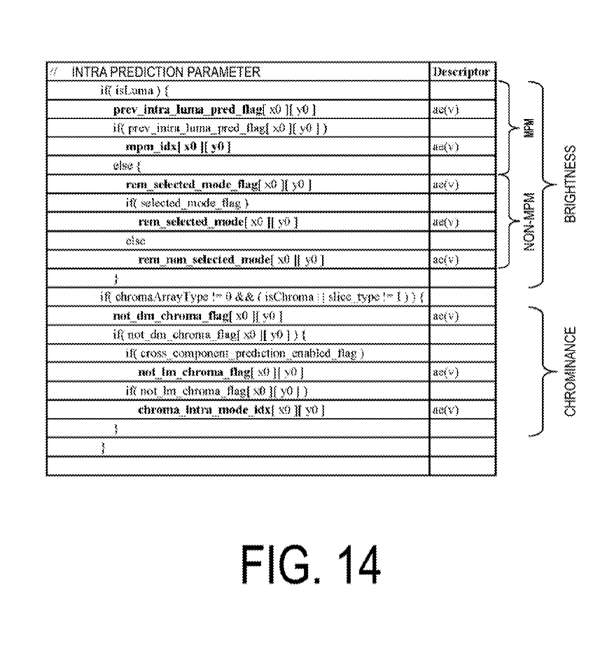

FIG. 14 is a schematic diagram illustrating an intra prediction parameter in the syntax of the CU illustrated in FIG. 13. As illustrated in FIG. 14, the coding_unit function specifies an intra prediction mode IntraPredModeY [x0] [y0] applied to a luminance pixel using five following syntax elements.

prev_intra_luma_pred_flag [x0] [y0]

mpm_idx [x0] [y0]

rem_selected_mode_flag [x0] [y0]

rem_selected_mode [x0] [y0]

rem_non_selected_mode [x0] [y0]

### MPM

prev_intra_luma_pred_flag [x0] [y0] is a flag indicating a concordance of the intra prediction mode IntraPredModeY [x0] [y0] and the Most Probable Mode (MPM) of the target PU (block). The MPM is a prediction mode included in an MPM candidate list, and is an intra prediction mode value estimated that the probability of being applied in the target PU is high, and 1 or more values are derived. Note that in a case that there are multiple MPMs, the MPMs may be referred to as the MPM collectively.

mpm_idx [x0] [y0] is an MPM candidate mode index to select the MPM.

### REM

rem_selected_mode_Flag [x0] [y0] is a flag to specify whether to perform an intra prediction mode selection referring to rem_selected_mode [x0] [y0] or perform an intra prediction mode selection referring to rem_non_selected_mode [x0] [y0].

rem_selected_mode [x0] [y0] is a syntax to specify RemIntraPredMode

rem_non_selected_mode [x0] [y0] is a syntax to specify RemIntraPredMode which is not specified by rem_selected_mode [x0] [y0].

Note that RemIntraPredMode is a temporary variable to calculate the intra prediction mode IntraPredModeY [x0] [y0]. RemIntraPredMode selects remaining modes other than the intra prediction modes corresponding to the MPM from the all intra prediction modes. The intra prediction mode which is selectable as RemIntraPredMode is referred to as “non-MPM” or “REM”.

REM is a luminance intra prediction mode, and a prediction mode other than the MPM (not included in an MPM candidate list). 0 (PLANAR) and 1 (DC) among intra prediction mode numbers are always included in the MPM, and thus REM is a directional prediction mode. The REM is selected by RemIntraPredMode. Values of RemIntraPredMode and intra prediction mode numbers are associated with each other so that values of RemIntraPredMode are in an ascending order to intra prediction mode numbers from bottom left (2) to top right (66) in order of rotating clockwise in the example illustrated in FIG. 12.

### Configuration of Intra Prediction Parameter Coding Unit 113

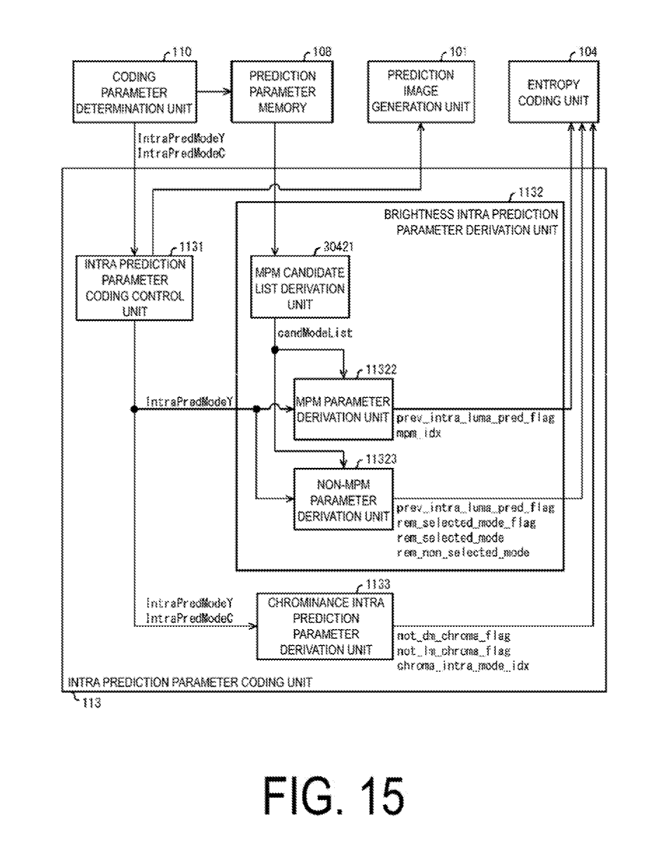

FIG. 15 is a schematic diagram illustrating a configuration of the intra prediction parameter coding unit 113 of the prediction parameter coding unit 111 of the image coding apparatus 11 illustrated in FIG. 6. As illustrated in FIG. 15, the intra prediction parameter coding unit 113 is configured to include an intra prediction parameter coding control unit 1131, a luminance intra prediction parameter derivation unit 1132, and a chrominance intra prediction parameter derivation unit 1133.

The intra prediction parameter coding control unit 1131 receives supply of a luminance prediction mode IntraPredModeY and a chrominance prediction mode IntraPredModeC from the coding parameter determination unit 110. The intra prediction parameter coding control unit 1131 supplies (controls) IntraPredModeY/C to the prediction image generation unit 101. The intra prediction parameter coding control unit 1131 supplies the luminance prediction mode IntraPredModeY to a following MPM parameter derivation unit 11322 and a non-MPM parameter derivation unit 11323. The intra prediction parameter coding control unit 1131 supplies the luminance prediction mode IntraPredModeY and the chrominance prediction mode IntraPredModeC to the chrominance intra prediction parameter derivation unit 1133.

The luminance intra prediction parameter derivation unit 1132 is configured to include an MPM candidate list derivation unit 30421 (a candidate list derivation unit), the MPM parameter derivation unit 11322, and the non-MPM parameter derivation unit 11323 (a coding unit, a derivation unit).

The MPM candidate list derivation unit 30421 receives supply of prediction parameters stored in the prediction parameter memory 108. The MPM candidate list derivation unit 30421 supplies the MPM candidate list candModeList to the MPM parameter derivation unit 11322 and the non-MPM parameter derivation unit 11323. In the following, the MPM candidate list candModeList is merely described as the “MPM candidate list”.

The MPM parameter derivation unit 11322 supplies the above-mentioned prev_intra_luma_pred_flag and mpm_idx to the entropy coding unit 104. The non-MPM parameter derivation unit 11323 supplies the above-mentioned prev_intra_luma_pred_flag, rem_selected_mode_flag, rem_selected_mode, and rem_non_selected_mode to the entropy coding unit 104. The chrominance intra prediction parameter derivation unit 1133 supplies the following not_dm_chroma_flag, not_lm_chroma_flag, and chroma_intra_mode_idx to the entropy coding unit 104.

### Configuration of Intra Prediction Parameter Decoding Unit 304

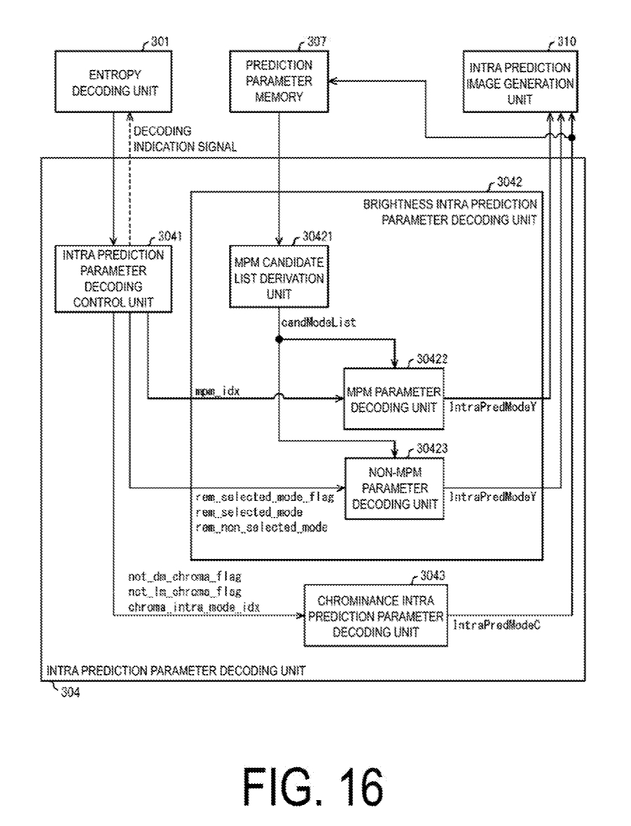

FIG. 16 is a schematic diagram illustrating a configuration of the intra prediction parameter decoding unit 304 of the prediction parameter decoding unit 302 of the image decoding apparatus 31 illustrated in FIG. 5. As illustrated in FIG. 16, the intra prediction parameter decoding unit 304 is configured to include an intra prediction parameter decoding control unit 3041, a luminance intra prediction parameter decoding unit 3042, and a chrominance intra prediction parameter decoding unit 3043.

The intra prediction parameter decoding control unit 3041 receives supply of codes from the entropy decoding unit 301. The intra prediction parameter decoding control unit 3041 supplies decoding indication signals to the entropy decoding unit 301. The intra prediction parameter decoding control unit 3041 supplies the above-mentioned mpm_idx to a following MPM parameter decoding unit 30422. The intra prediction parameter decoding control unit 3041 supplies the above-mentioned rem_selected_mode_flag, rem_selected_mode, and rem_non_selected_mode to a following non-MPM parameter decoding unit 30423. The intra prediction parameter decoding control unit 3041 supplies the above-mentioned not_dm_chroma_flag, not_lm_chroma_flag, and chroma_intra_mode_idx to the chrominance intra prediction parameter decoding unit 3043.

The luminance intra prediction parameter decoding unit 3042 is configured to include the MPM candidate list derivation unit 30421, the MPM parameter decoding unit 30422, and the non-MPM parameter decoding unit 30423 (a decoding unit, a derivation unit).

The MPM candidate list derivation unit 30421 supplies an MPM candidate list to the MPM parameter decoding unit 30422 and the non-MPM parameter decoding unit 30423.

The MPM parameter decoding unit 30422 and the non-MPM parameter decoding unit 30423 supply the above-mentioned luminance prediction mode IntraPredModeY to the intra prediction image generation unit 310.

The chrominance intra prediction parameter decoding unit 3043 supplies the chrominance prediction mode IntraPredModeC to the intra prediction image generation unit 310.

### Derivation Method 1 of Intra Prediction Parameter (Brightness)

In a case that prev_intra_luma_pred_flag [x0] [y0] is 1, the prediction parameter decoding unit 302 selects the intra prediction mode IntraPredModeY [x0] [y0] of the target block (PU) in luminance pixels from the MPM candidate list. The MPM candidate list (candidate list) is a list including multiple (for example, six) intra prediction modes, and is derived from intra prediction modes of adjacent blocks and prescribed intra prediction modes.

The MPM parameter decoding unit 30422 selects the intra prediction mode IntraPredModeY [x0] [y0] stored in the MPM candidate list using mpm_idx [x0] [y0] described in the syntax illustrated in FIG. 14.

### Derivation Method 2 of Intra Prediction Parameter (Brightness)

A derivation method of the MPM candidate list will now be described. The MPM candidate list derivation unit 30421 determines at any time whether or not a certain prediction mode is already included in the MPM candidate list. The MPM candidate list derivation unit 30421 does not add a prediction mode included in the MPM candidate list to the MPM candidate list redundantly. In a case that the number of prediction modes of the MPM candidate list becomes the prescribed number (for example, six), the MPM candidate list derivation unit 30421 finishes derivation of the MPM candidate list.

### 1. Addition of Neighboring Mode and Plane Mode

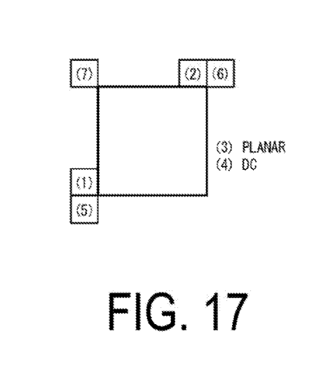

FIG. 17 is a schematic diagram illustrating an order of a prediction mode in a case that the MPM candidate list derivation unit 30421 adds to the MPM candidate list in the intra prediction parameter coding unit 113 illustrated in FIG. 15, and in the intra prediction parameter decoding unit 304 illustrated in FIG. 16. As illustrated in FIG. 17, the MPM candidate list derivation unit 30421 adds neighboring modes and plane modes to the MPM candidate list in the following order.

(1) The intra prediction mode (neighboring mode) of the left block of the target block

(2) The intra prediction mode (neighboring mode) of the top block of the target block

(3) PLANAR prediction mode (plane mode)

(4) DC prediction mode (plane mode)

(5) The intra prediction mode (neighboring mode) of the bottom left block of the target block

(6) The intra prediction mode (neighboring mode) of the top right block of the target block

(7) The intra prediction mode (neighboring mode) of the top left block of the target block

### 2. Addition of Derived Mode

The MPM candidate list derivation unit 30421 adds derived modes that are prediction modes before and after the prediction mode, in other words, where mode numbers illustrated in FIG. 12 are ±1, to the MPM candidate list, for each of directional prediction modes (other than the PLANAR prediction and the DC prediction) in the MPM candidate list.

### 3. Addition of Default Mode

The MPM candidate list derivation unit 30421 adds a default mode to the MPM candidate list. The default mode includes prediction modes where mode numbers are 50 (vertical/VER), 18 (horizontal/HOR), 2 (bottom left), or 34 (top left diagonal/DIA).

Note that the prediction mode (bottom left) where the mode number is 2 and the prediction mode (top right/VDIA) where the mode number is 66 are considered next to each other (the mode number are ±1) for convenience.

### Derivation Method of MPM Candidate List

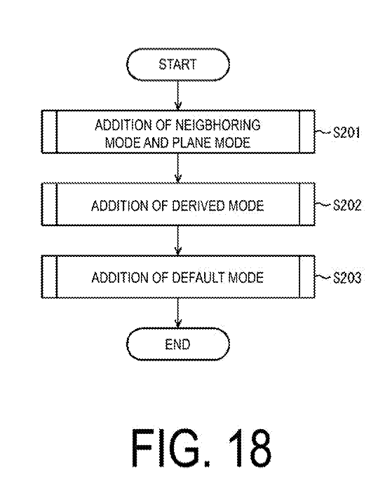

FIG. 18 a flowchart illustrating an operation that the MPM candidate list derivation unit 30421 derives the MPM candidate list in the intra prediction parameter coding unit 113 illustrated in FIG. 15, and in the intra prediction parameter decoding unit 304 illustrated in FIG. 16. As illustrated in FIG. 18, the operation that the MPM candidate list derivation unit 30421 derives the MPM candidate list includes step S201, S202, and S203.

### Step S201

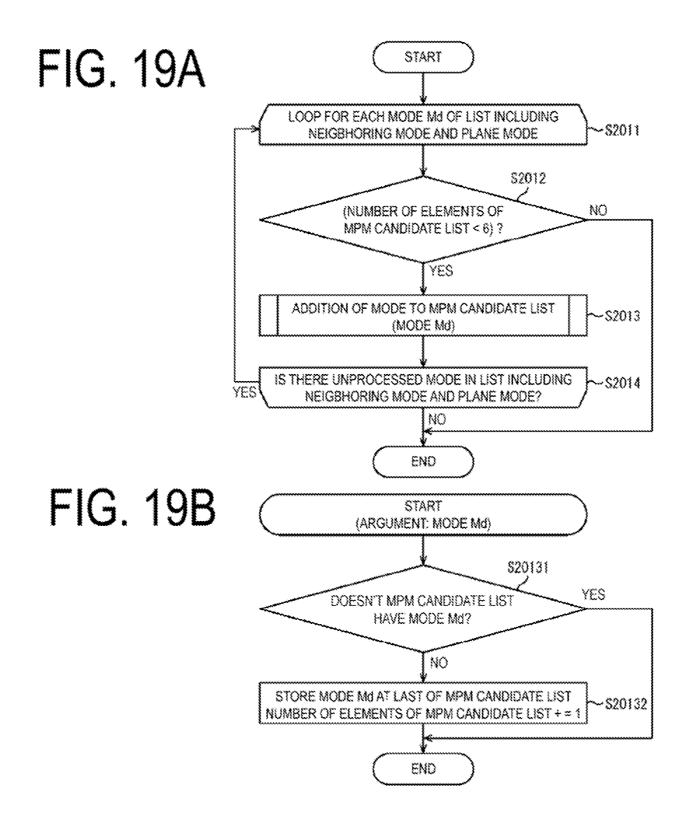

The MPM candidate list derivation unit 30421 adds a neighboring mode and a plane mode to the MPM candidate list. FIG. 19A is a flowchart illustrating details of step S201 of the operation illustrated in FIG. 18. As illustrated in FIG. 19A, step S201 includes steps S2011 to S2014.

### Step S2011

The MPM candidate list derivation unit 30421 starts loop processing for each mode Md of a list including a neighboring mode and a plane mode. Here, the i-th element of the list of the loop target is substituted for Md for every one time of a loop (the same applies to loops even on other lists). Note that “a list including a neighboring mode and a plane mode” is a temporary concept for description. This does not indicate a real data structure, and elements included are processed in a prescribed order.

### Step S2012

The MPM candidate list derivation unit 30421 determines whether or not the number of elements in the MPM candidate list is smaller than a prescribed number (for example, 6). In a case that the number of elements is smaller than 6 (YES), step S2013 is performed. In a case that the number of elements is not smaller than 6 (NO), step S201 ends.

### Step S2013

FIG. 19B is a flowchart illustrating details, of step S2013 of step S201 illustrated in FIG. 19A. As illustrated in FIG. 19B, step S2013 includes steps S20131 and S20132.

In step S20131, the MPM candidate list derivation unit 30421 determines whether or not the MPM candidate list includes the mode Md. In a case that the MPM candidate list does not include the mode Md (NO), step S20132 is performed. In a case that the MPM candidate list includes the mode Md (YES), step S2013 ends.

In step S20132, the MPM candidate list derivation unit 30421 adds the mode Md to the last of the MPM candidate list, and increases the number of elements of the MPM candidate list by 1.

### Step S2014

The MPM candidate list derivation unit 30421 determines whether or not there is an unprocessed mode in a list including a neighboring mode and a plane mode. In a case that there is an unprocessed mode (YES), step S2011 is performed again. In a case that there is not an unprocessed mode (NO), step S201 ends.

### Step S202 (FIG. 18)

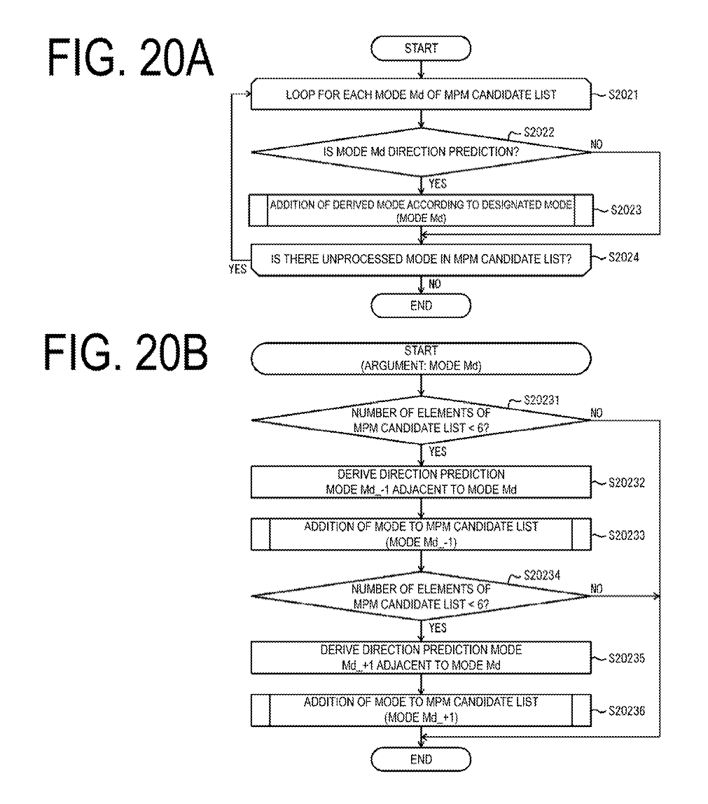

The MPM candidate list derivation unit 30421 adds a derived mode to the MPM candidate list. FIG. 20A is a flowchart illustrating details of step S202 of the operation illustrated in FIG. 18. As illustrated in FIG. 20A, step S202 includes steps S2021 to S2024.

### Step S2021

The MPM candidate list derivation unit 30421 starts loop processing for each mode Md of the MPM candidate list.

### Step S2022

The MPM candidate list derivation unit 30421 determines whether or not the mode Md is a directional prediction. In a case that the mode Md is a directional prediction (YES), step S2023 is performed, and step S2024 is performed. In a case that the mode Md is not a directional prediction (NO), step S2024 is performed.

### Step S2023

FIG. 20B is a flowchart illustrating details of step S2023 of step S202 illustrated in FIG. 20A. As illustrated in FIG. 20B, step S2023 includes steps S20231 to S20236.

In step S20231, the MPM candidate list derivation unit 30421 determines whether or not the number of elements in the MPM candidate list is smaller than 6. In a case that the number of elements is smaller than 6 (YES), step S20232 is performed. In a case that the number of elements is not smaller than 6 (NO), step S2023 ends.

In step S20232, the MPM candidate list derivation unit 30421 derives the directional prediction mode Md_−1 adjacent to the mode Md. As described above, the mode Md is determined to be the directional prediction mode in step S2022, and the mode number corresponding to the mode Md is any of 2 to 66 illustrated in FIG. 12. At this time, the directional prediction mode Md_−1 adjacent to the mode Md is the directional prediction mode corresponding to the mode number that is the mode number subtracted 1 from the mode number corresponding to the mode Md. However, in a case that the mode number corresponding to the mode Md is 2, the directional prediction mode Md_−1 adjacent to the mode Md is the prediction direction mode corresponding to the mode number 66.

In step S20233, Md_−1 is given to the argument Md of step S2013 illustrated in FIG. 19B and is processed.

In step S20234, the MPM candidate list derivation unit 30421 determines whether or not the number of elements in the MPM candidate list is smaller than 6. In a case that the number of elements is smaller than 6 (YES), step S20235 is performed. In a case that the number of elements is not smaller than 6 (NO), step S2023 ends.

In step S20235, the MPM candidate list derivation unit 30421 derives the directional prediction mode Md_+1 adjacent to the mode Md. The directional prediction mode Md_+1 adjacent to the mode Md is the directional prediction mode corresponding to the mode number that is the mode number added 1 to the mode number corresponding to the mode Md. However, in a case that the mode number corresponding to the mode Md is 66, the directional prediction mode Md_+1 adjacent to the mode Md is the mode number 2.

In step S20236, Md_+1 is given to the argument Md of step S2013 illustrated in FIG. 19B and is processed.

### Step S2024

The MPM candidate list derivation unit 30421 determines whether or not there is an unprocessed mode in the MPM candidate list. In a case that there is an unprocessed mode in the MPM candidate list (YES), step S2021 is performed again. In a case that there is not an unprocessed mode in the MPM candidate list (NO), step S202 ends.

### Step S203 (FIG. 18)

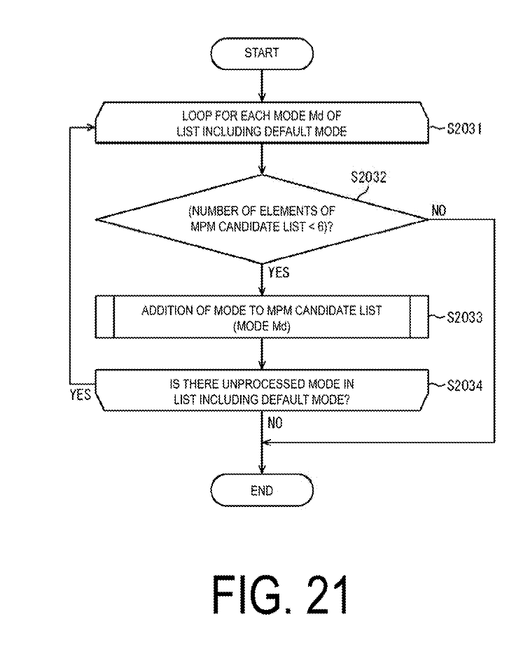

The MPM candidate list derivation unit 30421 adds a default mode to the MPM candidate list. FIG. 21 is a flowchart illustrating details of step S203 of the operation illustrated in FIG. 18. As illustrated in FIG. 21, step S203 includes steps S2031 to S2034.

### Step S2031

The MPM candidate list derivation unit 30421 starts loop processing for each mode Md of a list including the default mode.

### Step S2032

The MPM candidate list derivation unit 30421 determines whether or not the number of elements in the MPM candidate list is smaller than 6. In a case that the number of elements is smaller than 6 (YES), step S2033 is performed. In a case that the number of elements is not smaller than 6 (NO), step S203 ends.

### Step S2033

In step S2033, Md in step S2031 is given to the argument Md of step S2013 illustrated in FIG. 19B and is processed.

### Step S2034

The MPM candidate list derivation unit 30421 determines whether or not there is an unprocessed mode in the list including the default mode. In a case that there is an unprocessed mode (YES), step S2031 is performed again. In a case that there is not an unprocessed mode (NO), step S203 ends.

### Derivation Method 3 of Intra Prediction Parameter (Brightness)

When prev_intra_luma_pred_flag [x0] [y0] is 0, the non-MPM parameter decoding unit 30423 derives the intra prediction mode IntraPredModeY [x0] [y0] of the target block (PU) in luminance pixels using RemIntraPredMode and the MPM candidate list.

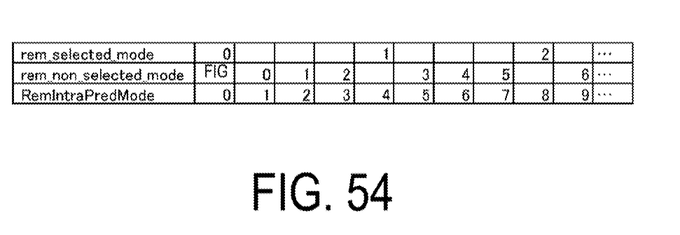

At first, in a case that rem_selected_mode_flag [x0] [y0] is 1, RemIntraPredMode is the value where the value of rem_selected_mode is bit shifted by 2 bits to the left. In a case that rem_selected_mode_flag [x0] [y0] is 0. RemIntraPredMode is the value where the value of rem_non_selected mode is multiplied by 4, the result is divided by 3, and 1 is added to the quotient. FIG. 54 indicates a correspondence of rem_selected_mode, rem_non_selected_mode, and RemIntraPredMode. RemIntraPredMode may be calculated using a table such as in FIG. 54 rather than using the above-mentioned calculation.

Note that calculation of RemIntraPredMode is not limited to the above-mentioned example. Furthermore, the correspondence of the values of RemIntraPredMode, rem_selected_mode, and rem_non_selected_mode may be different from the above-mentioned example. For example, in a case that rem_selected_mode_flag [x0] [y0] is 1, RemIntraPredMode can be calculated by assuming the value where the value of rem_selected_mode is bit shifted by 3 bits to the left as RemIntraPredMode, and in a case that rem_selected_mode_flag [x0] [y0] is 0, RemIntraPredMode can be calculated by assuming the value where rem_non_selected_mode is multiplied by 8, the result is divided by 7, and 1 is added to the quotient to be RemIntraPredMode.

In a case that rem_selected_mode [x0] [y0] is fixed length coded, as illustrated in FIG. 54, by dispersedly assigning rem_selected_mode to RemIntraPredMode, the value of the mode number does not influence a code amount of coded data, and bias of direction selection is effectively decreased.

### Derivation Method 4 of Intra Prediction Parameter (Brightness)

Since RemIntraPredMode represents the serial numbers provided to the non-MPM, to derive IntraPredModeY [x0] [y0], modification by comparison with the prediction mode value of the MPM included in the MPM candidate list is necessary. The exemplification of the derivation processing by pseudo codes is as follows.

intraPredMode = RemIntraPredMode
sortedCandModeList = sort (candModeList) // sort in the ascending order
of the mode numbers

for (i = 0; i < size of sortedCandModeList, i++) {

if (intraPredMode >= sortedCandModeList [i]) {

intraPredMode += 1

}

}
IntraPredModeY [x0] [y0] = intraPredMode

After having initialized the variable intraPredMode its RemIntraPredMode, the non-MPM parameter decoding unit 30423 compares with RemIntraPredMode from smaller prediction mode values included in the MPM candidate list sequentially, and adds 1 to intraPredMode in a case that a prediction mode value is smaller than intraPredMode. The value of intraPredMode obtained by performing this processing for all elements of the MPM candidate list is IntraPredModeY [x0] [y0].

### Derivation Method 5 of Intra Prediction Parameter (Brightness)

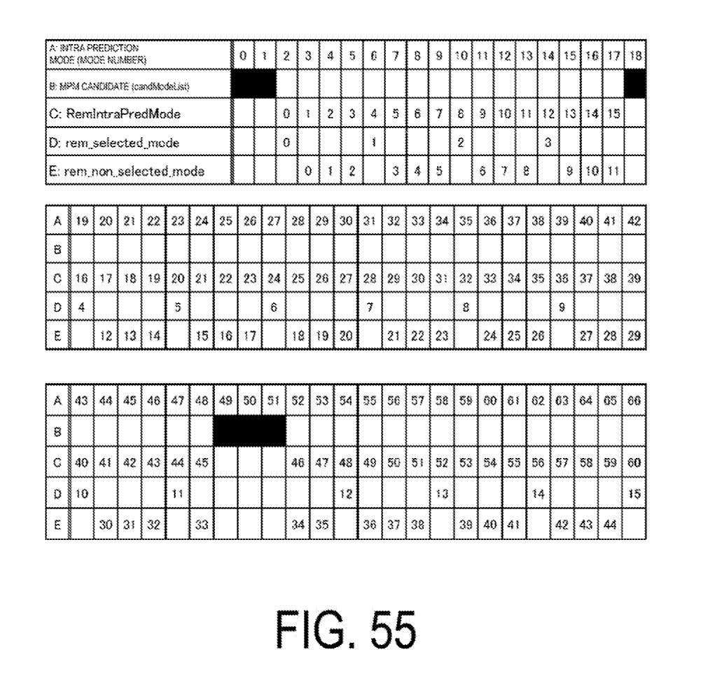

FIG. 55 is a table illustrating relationships of the MPM candidate (candModeList), RemIntraPredMode, rem_selected_mode, and rem_non_selected_mode in a case of assuming intra prediction modes (mode numbers) 0, 1, 18, and 49 to 51 (black) as the MPM candidates (candModeList).

The REM is classified into selected mode and non-selected mode as above.

### Selected Mode

In selected mode, the remainder of RemIntraPredMode divided by 4 is 0. The serial numbers (rem_selected_mode) in selected mode are fixed length coded (4 bits). There is no difference in bit numbers of coded data depending on directions of prediction modes, or in other words, directional bias of prediction mode selection can be reduced in the image coding apparatus 11 (FIG. 6).

### Non-Selected Mode

The serial numbers (rem_non_selected_mode) in non-selected mode are variable length coded. Since coded rem_non_selected_mode is variable length coding, bit numbers of coded data vary depending on directions of prediction modes. Specifically, the bit numbers are 5 bits or 6 bits, and 20 prediction mode numbers from having smaller prediction mode numbers are coded at 5 bits. Even in a case of coding at 5 bits or 6 bits similarly to this, a code amount can be reduced by associating prediction directions that are more likely to be selected with shorter codes. Alternatively, a code amount can be reduced more by taking a wider range (for example, range from 4 bits to 8 bits) of bit numbers of the coded data of rem_non_selected_mode, and associating the prediction direction that is more likely to be selected with a shorter code (4 bits).

### Derivation Method 1 of Intra Prediction Parameter (Chrominance)

The intra prediction mode IntraPredModeC [x0] [y0] applied to chrominance pixels will be described using FIG. 14. The intra prediction mode IntraPredModeC [x0] [y0] is calculated using three following syntax elements.

not_dm_chroma_flag [x0] [y0]

not_lm_chroma_flag [x0] [y0]

chroma_intra_mode_idx [x0] [y0]

not_dm_chroma_flag [x0] [y0] is a flag being 1 in a case of not using intra prediction modes of luminance, not_lm_chroma_flag [x0] [y0] is a flag being 1 in a case of using the prediction mode list ModeList and in a case of not performing a linear prediction by luminance pixels. chroma_intra_mode_idx [x0] [y0] is an index specifying an intra prediction mode applied to chrominance pixels. Note that x0 and y0 are coordinates of the upper left luminance pixel of a target block in a picture and are not coordinates of an upper left chrominance pixel. In a case of two flags (not_dm_chroma_flag [x0] [y0] and not_lm_chroma_flag [x0] [y0]) are both 1, the intra prediction mode IntraPredModeC [x0] [y0] is derived by the prediction mode list ModeList. The exemplification of the derivation processing by pseudo codes is as follows.

if (not_dm_chroma_flag [x0] [y0] == 0) {

// DM_CHROMA: use the intra prediction mode of luminance
IntraPredModeC [x0] [y0] = IntraPredModeY [x0] [y0]

} else {

if (not_lm_chroma_flag[x0] [y0] == 0) {// the value is 1 if not in
the coded data

IntraPredModeC [x0] [y0] = LM_CHROMA // linear prediction
by luminance pixels

} else {

IntraPredModeC [x0] [y0] = ModeList
[chroma_intra_mode_idx [x0] [y0]]

}

}

Note that in a case that a chrominance format is 4:2:2, in using DM_CHROMA for an intra prediction mode of chrominance, IntraPredModeC [x0] [y0] is derived by transforming a prediction direction indicated by IntraPredModeY [x0] [y0] using a transform table or a transform formula in contrast to the pseudo code.

### Derivation Method 2 of Intra Prediction Parameter (Chrominance)

The prediction mode list ModeList chrominance is derived as follows.

ModeList [ ]={PLANAR, VER, HOR, DC}

However, in a case that IntraPredModeY [x0] [y0] coincides with ModeList (i) (i=0 to 3), ModeList [i] is as follows.

ModeList [i]=VDIA

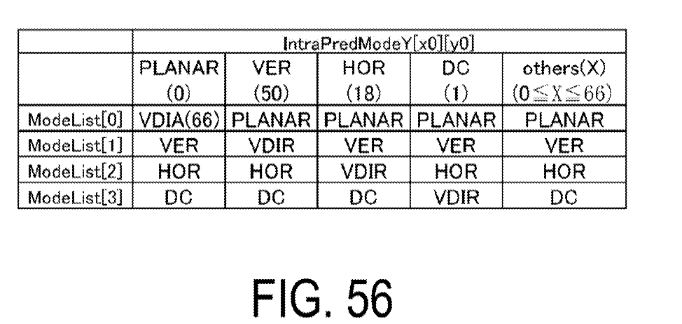

In other words, ModeList [i] is as the table illustrated in FIG. 56. ModeList is determined by IntraPredModeY [x0] [y0]. The suffix (0 to 3) of ModeList is selected by chroma_intra_mode_idx [x0] [y0].

The entropy coding unit 104 binarizes various parameters, and then performs entropy coding. After having entropy decoded coded data, the entropy decoding unit 301 multivalues it from binary. Since binarization and multivaluing are inverse processing, they are collectively referred to as binarization hereinafter.

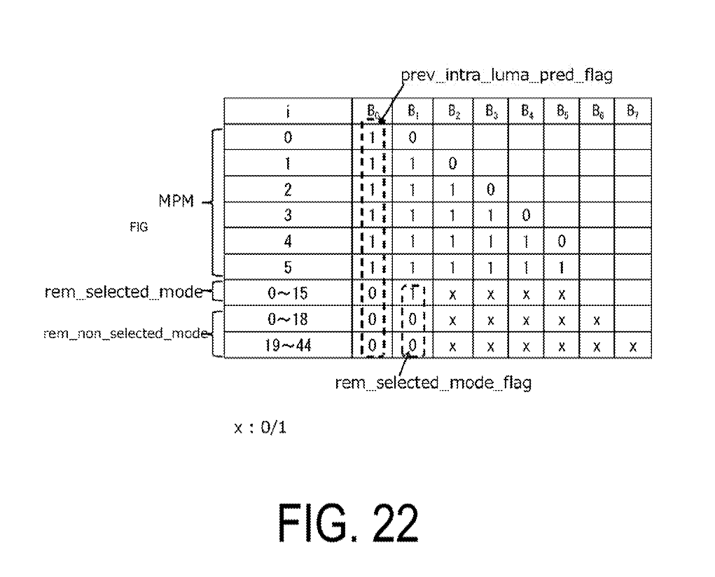

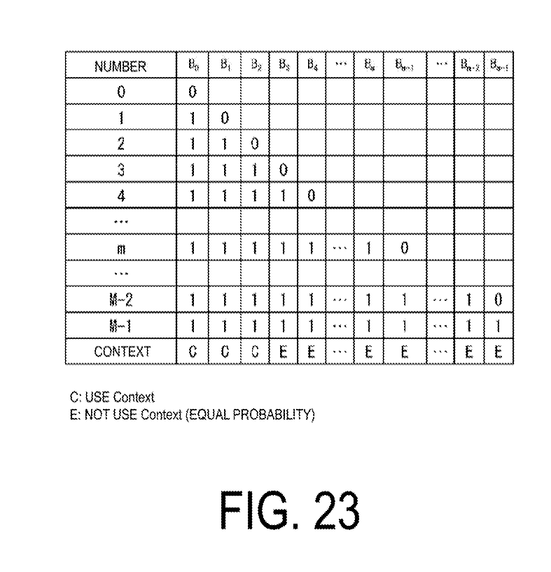

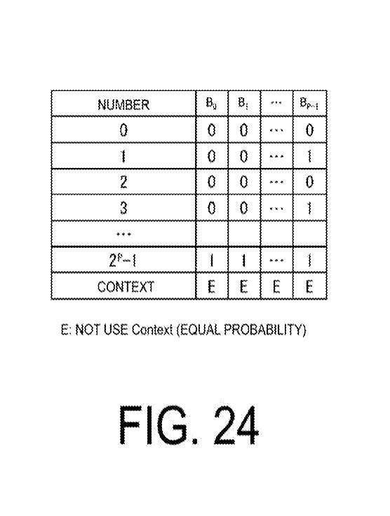

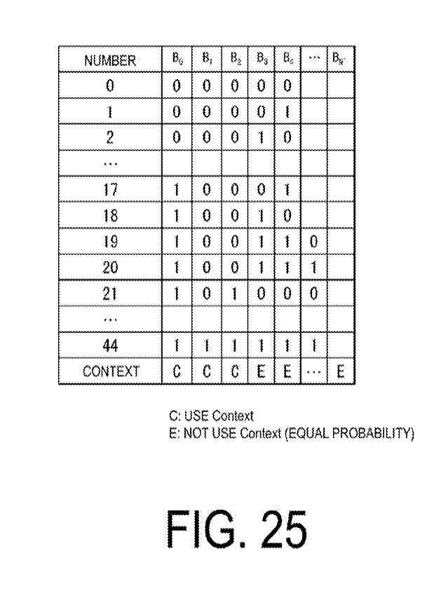

Binarization in a case that the entropy coding unit 104 or the entropy decoding unit 301 codes or decodes these intra prediction modes will be described now. FIG. 22 is a diagram illustrating a code of i expressing the intra prediction mode as MPM, rem_selected_mode, and rem_non_selected_mode. i=0 to 5 is the intra prediction mode (MPM) included in the MPM candidate list, and the entropy coding unit 104 codes i using first prev_intra_luma_pred_flag (=1) and then truncated rice code (TR code) illustrated in FIG. 23 depending on i. The entropy coding unit 104 codes rem_selected_mode (i=0 to 15) using first prev_intra_luma_pred_flag (=0), rem_selected_mode_flag (=1), followed by a fixed length code illustrated in FIG. 24. FIG. 24 is a fixed length code of a bit length P=4. The entropy coding unit 104 codes rem_non_selected_mode (i=0 to 44) using first prev_intra_luma_pred_flag (=0), rem_selected_mode_flag (=0), followed by a variable length code illustrated in FIG. 25. In FIG. 23 to FIG. 25 and following diagrams, a symbol C of the context indicates to use the context in entropy coding, and a symbol E indicates not to use the context in entropy coding (Equal Probability EQ). The entropy decoding unit 301 also decodes coded data in a similar procedure.

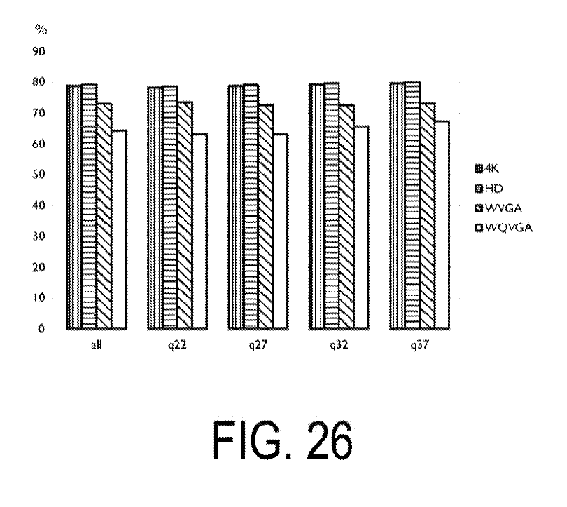

FIG. 26 is a graph of investigated occurrence frequency of the MPM in a case that there are six MPMs (mpm_idx=0 to 5). FIG. 26 illustrates the results expressing occurrence frequency of the MPM in percentage in a case of having changed quantization step sizes q to 22, 27, 32, and 37 using images of four types of resolutions including 4K, HD, WVGA, and WQVGA. “all” at the left is an average of four quantization step sizes (q=22, 27, 32, 37). The occurrence frequencies of the MPM in images of any resolutions and any quantization step sizes is in the range of 60% to 80%, and exceed 70% particularly in 4K and HD which are being spreading rapidly in late years. On the other hand, RemIntraPredMode remains in 20% to 40%, and does not reach 30% in 4K and HD. In other words, a code amount of the MPM of the high occurrence frequency can be reduced, and, as a result, coding efficiency can be improved, by not coding prev_intra_luma_pred_flag for distinguishing RemIntraPredMode from MPM.

The syntax describing a coding/decoding method of the intra prediction mode without using prev_intra_luma_pred_flag is illustrated below. The present embodiment makes only distinction of selected_mode and non-selected_mode by removing prev_intra_luma_pred_flag and also removing distinction of MPM and non-MPM (RemIntraPredMode) like the following syntax.

non_selected_mode_flag
if (non_selected_mode_flag) {

smode

}
else {

rem_selected_mode

}

Here, rem_selected_mode is syntax indicating selected_mode, and smode (sorted mode) is syntax indicating non-selected_mode. non_selected_mode_flag is a flag indicating whether or not the following syntax is selected_mode. rem_selected_mode list is defined as a list storing non-selected_mode, and smode list is defined as a list storing smode. Note that, for example, the rem_selected_mode list and the smode list may store values or labels of the intra prediction mode.

The smode list (non-selected_mode) is constituted by MPM and rem_non_selected_mode. The first M pieces of the smode list store the intra prediction mode indicated by mpm_idx stored in the MPM candidate list, and after that rem_non_selected mode (45 pieces) are stored.

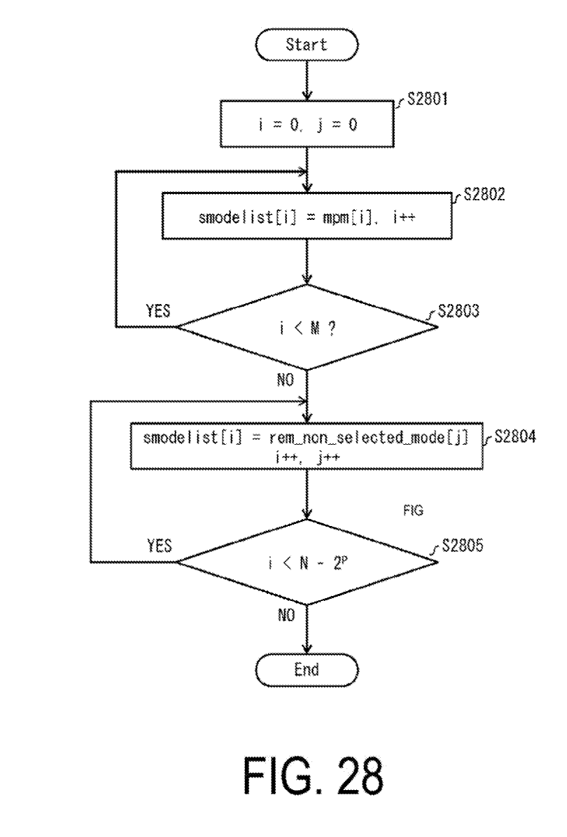

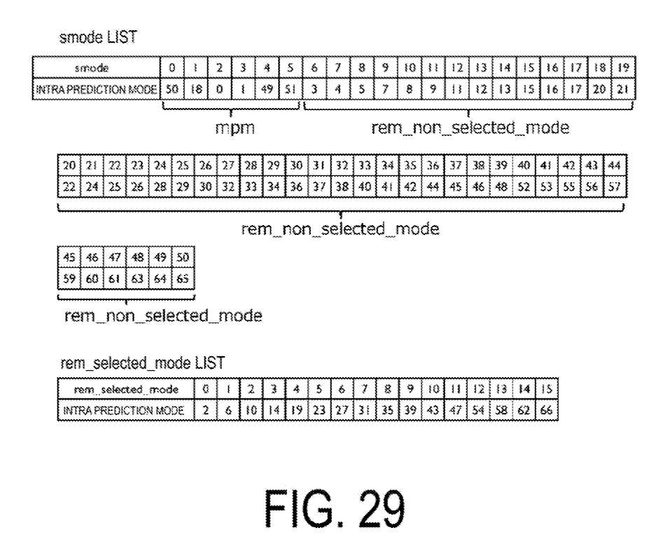

The creation procedure of the smode list by the luminance intra prediction parameter derivation unit 1132 and the luminance intra prediction parameter decoding unit 3042 is illustrated in FIG. 28. The luminance intra prediction parameter derivation unit 1132 and the luminance intra prediction parameter decoding unit 3042 initializes the variable i which indicates the position in the smode list and the variable j which indicates the number from the beginning of the rem_non_selected_mode (N-M-2^{P}) pieces in S2801. Here, N is the number of intra prediction modes, M is the number of MPM, and 2^{P} is the number of rem_selected_mode (P is the number of bits necessary to express rem_selected_mode). Since MPM comes to the first of the smode list, i can be used commonly in the smode list and the MPM candidate list in a case that i is smaller than M (i<M). In S2802, intra prediction modes stored in the MPM candidate list are copied to the first M pieces (i=0 to M−1) of the smode list. In S2803, whether all the stored intra prediction modes in the MPM candidate list has finished being copied is determined. In a case that copies are still not finished (YES in S2803), S2802 is repeated, and in a case that all the copies are finished (NO in S2803), the operation advances to S2804. In S2804, the intra prediction mode which is categorized into rem_non_selected_mode is further copied into the smode list. In S2805, whether all rem_non_selected_mode has been finished copying is determined. In a case that copies are still not finished (YES in S2805), S2804 is repeated, and in a case that all the copies are finished (NO in S2805), the creation of the smode list is finished. An example of the smode list created by the processing is illustrated in FIG. 29 in a case of the intra prediction modes {50, 18, 0, 1, 49, 51} are stored in the MPM candidate list. The rem_selected_mode list which stores 2^{p} pieces of rem_selected_mode is illustrated.

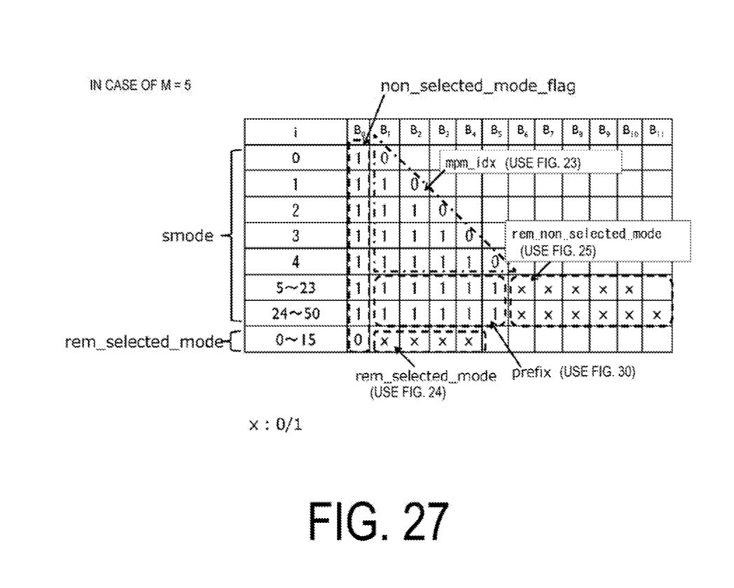

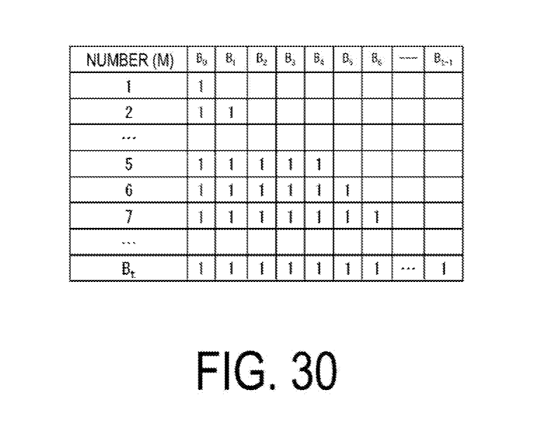

A specific example of the above syntax is illustrated in FIG. 27. In FIG. 27, i is the number indicating the position of each intra prediction mode in the smode list or the rem_selected_mode list. Bₖ of the horizontal axis indicates the k-th bit number of the code of i. Here, k is equal to 0 to 11. In FIG. 27, the entropy coding unit 104 at first codes non_selected_mode_flag which indicates whether or not selected_mode (rem_selected_mode) first. Then, in a case other than selected_mode, non_selected_mode_flag codes 1. Furthermore, the number i indicating the position on the smode list is coded. In a case that i indicates one of the MPM of M1 (M1 is equal to or smaller than M (M1<=M)) pieces stored in the MPM candidate list, it is coded using the TR code illustrated in FIG. 23 after non_selected_mode_flag(1). In a case that i indicates anything other than the MPM of M1 (M1 is equal to or smaller than M (M1<=M)) pieces stored in the MPM candidate list, remaining (M-M1) pieces of the MPM and rem_non_selected_mode are coded using the prefix of FIG. 30 and a variable length code table of FIG. 25. At this time, the code corresponding to the number of subtracting M1 from rem_non_selected_mode is used in FIG. 25. In a case of selected_mode, 0 is coded as non_selected_mode_flag, and in addition, the number i indicating the position of the intra prediction mode on the rem_selected_mode list which is a list of selected_mode is coded. Specifically, rem_selected_mode codes using the fixed length code table illustrated in FIG. 24 after non_selected_mode_flag(0). The entropy decoding unit 301 also decodes coded data in a similar procedure. However, in the entropy decoding unit 301, in a case of decoding smode (non_selected_mode_flag==1), i is the number of “1” before “0” appears, or in other words, mpm_idx. Alternatively, in a case of decoding rem_non_selected_mode (non_selected_mode_flag==0), i is the value of decoded rem_non_selected_mode.

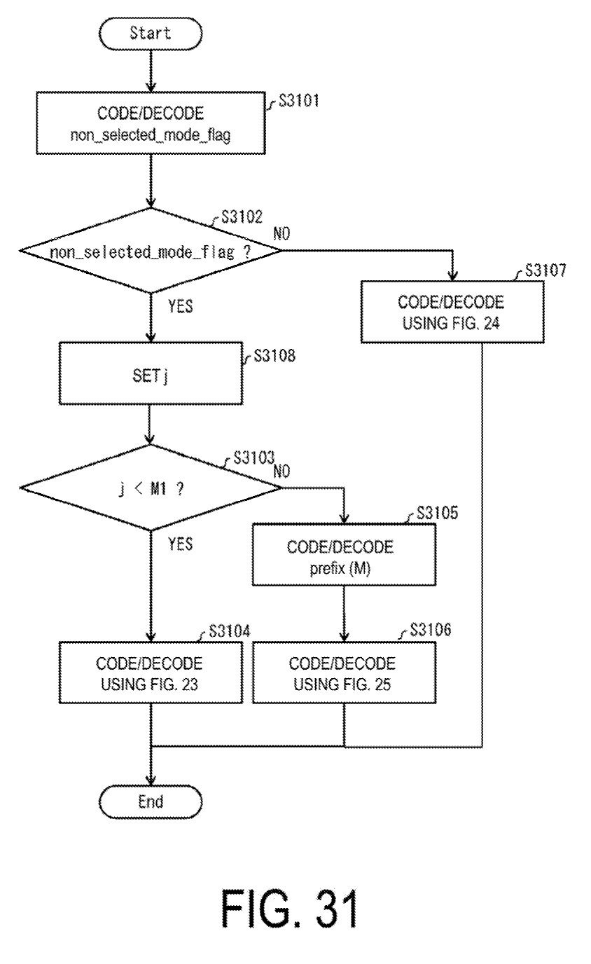

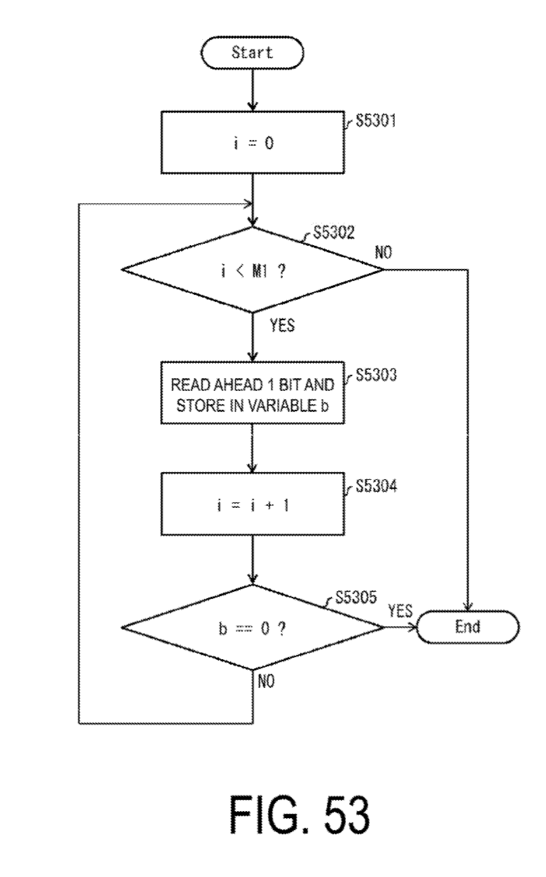

A flowchart describing an operation of the entropy coding unit 104 and the entropy decoding unit 301 coding or decoding the intra prediction mode is illustrated in FIG. 31. At first, the entropy coding unit 104 and the entropy decoding unit 301 codes/decodes non_selected_mode_flag in S3101. In S3102, whether or not non_selected_mode_flag is not 0 is determined, and in a case of not 0, (YES in S3102, or in other words, in a case of not selected_mode), the operation advances to S3108, and in a case of 0 (NO in S3102, or in other words, in a case of selected_mode), the operation advances to S3107. The entropy coding unit 104 sets the position i on each list of the intra prediction mode to the variable j in S3108. The entropy decoding unit 301 reads ahead the coded data and sets the number of “1” before “0” appears to the variable j in S3108. This operation will be described below using the flowchart of FIG. 53. In S3103, whether or not j is less than M1 is determined, and in a case of j being less than M1 (j<M1) (YES S3103), the operation advances to S3104, and in a case of j being not less than M1 (not j<M1) (NO in S3103), the operation advances to S3105. In S3104, any of the MPM of M1 pieces is coded/decoded using FIG. 23, and the processing is finished. In S3105, the prefix M1 is coded/decoded using FIG. 30. Subsequently, in S3106, any of the MPM of (M-M1) pieces or rem_non_selected_mode is coded decoded using FIG. 25, and the processing is finished. In S3107, rem_selected_mode is coded/decoded using FIG. 24, and the processing is finished.

FIG. 53 is a flowchart describing an example of the operation that the entropy decoding unit 301 reads ahead the coded data. The entropy decoding unit 301 initializes i in S5301. In S5302, whether or not i is smaller than M1 (i<M1) is determined, and in a case that i is smaller than M1 (i<M1) (YES in S5302), the operation advances to S5303, and in a case that i is not smaller than M1 (not i<M1) (NO in S5302), the processing is finished. In S5303, the coded data is read ahead 1 bit, and stored in the variable b. In S5304, i is incremented. In S5305, whether or not b is equal to 0 is determined, and in a case that b is equal to 0 (YES in S5305), the processing is finished, and in a case that b is not equal to 0 (NO in S5305), the processing continues processing after S5302. The value of i in a case that the processing is finished is the number of “1” before “0” appears.

Note that, although the entropy decoding unit 301 reads ahead the coded data in S3108 in the above, the operation is not limited to this, and the entropy decoding unit 301 may decode the coded data. In that case, the decoding of the MPM in S3104 and the decoding of the prefix in S3105 are not performed.

### Embodiment 2

As another embodiment not to code prev_intra_luma_pred_flag, a method to insert non_selected_mode_flag in the middle of the code will be described. Another embodiment not to code prev_intra_luma_pred_flag is a syntax to code the MPM from the beginning of the syntax indicating the intra prediction mode. This syntax is illustrated as follows.

smode
if (smode == M)

non_selected_mode_flag
if (non_selected_mode_flag) {

smode

}
else {

rem_selected_mode

}

}

Note that as an operation of an encoder,

if (smode < M)

smode

}
else {

Prefix (M)
non_selected_mode_flag
if (non_selected_mode_flag) {

smode

}
else {

rem_selected_mode

}

}

may be performed.

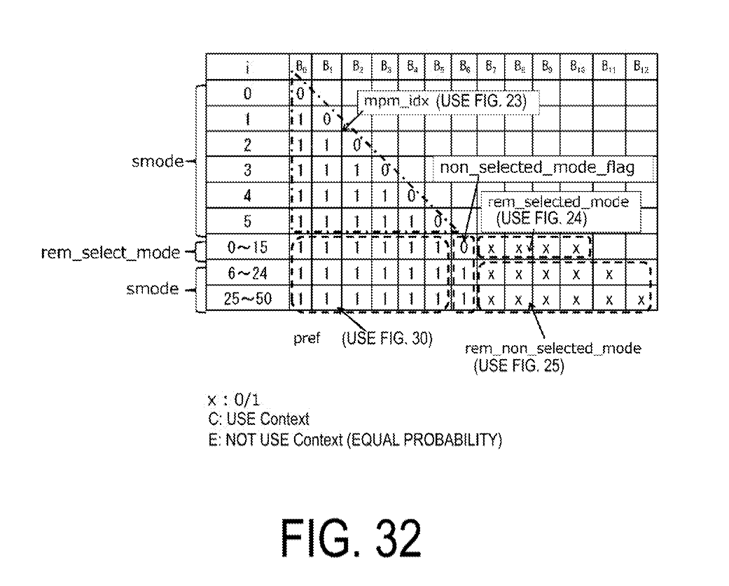

The entropy coding unit 104 codes a syntax smode indicating the MPM. As illustrated in FIG. 32, in a case that the intra prediction mode is any of the MPM of M pieces being at the beginning of the smode list, the position i (0<=i<M) on the list of the intra prediction mode in the smode list is coded as smode. Specifically, in a case of i is smaller than M (i<M), the Entropy coding unit 104 does not code non_selected_mode_flag, and codes smode using the table of FIG. 23. In a case that the intra prediction mode is not any of the MPM of M pieces being at the beginning of the smode list, M (prefix) is coded as smode. More specifically, the entropy coding unit 104 codes the prefix indicating M in FIG. 30. Subsequently, the entropy coding unit codes non_selected_mode_flag, and, in a case of not selected_mode, further codes any of the M-th intra prediction mode and subsequent intra prediction modes in the smode list using FIG. 25. At this time, the code of FIG. 25 corresponding to the number of subtracting M from rem_non_selected_mode is used. In a case of selected_mode, the prefix indicated by M in FIG. 30 is coded, and subsequently, any of the intra prediction modes in rem_selected_mode list is coded using FIG. 24.

The entropy decoding unit 301 also decodes coded data in a similar procedure. However, in the entropy decoding unit 301, i is the value of adding I to the number of “1” before “0” appears. Subsequently, in a case of i is equal to M (i=N), non_selected_mode_flag and a subsequent syntax are decoded.

A specific example of the syntax is illustrated in FIG. 32. By inserting the prefix (“111111” in FIG. 32), individual intra prediction modes can be identified even in a case of not applying non_selected_mode_flag to all intra prediction modes. For example, in the example of FIG. 32, the MPM can be identified to be stored at the beginning of the smode list in a case of including “0” from the beginning (the first bit) to the sixth bit. In a case that from the beginning (the first bit) to the sixth bit are all “1”, it is rem_selected_mode or rem_non_selected_mode. Which one it is can be determined by non_selected_mode_flag inserted into the seventh bit. Thus, at the beginning of the syntax of the intra prediction mode, the MPM which specifically appears frequently can be expressed with a shorter code, by not coding the syntax (for example, prev_intra_luma_pred_flag or non_selected_mode_flag) indicating the classification of the intra prediction modes, but coding the MPM (the MPM of the first M pieces) directly. Thereby, coding efficiency can be improved. There may be a configuration where the syntax indicating the classification of the intra prediction modes, here non_selected_mode_flag, is coded after the prefix. In this case, by classifying intra prediction modes, additional effects of being able to assign appropriate entropy coding to different types of intra prediction modes can be obtained without increasing the code amount of the first MPM of smode.

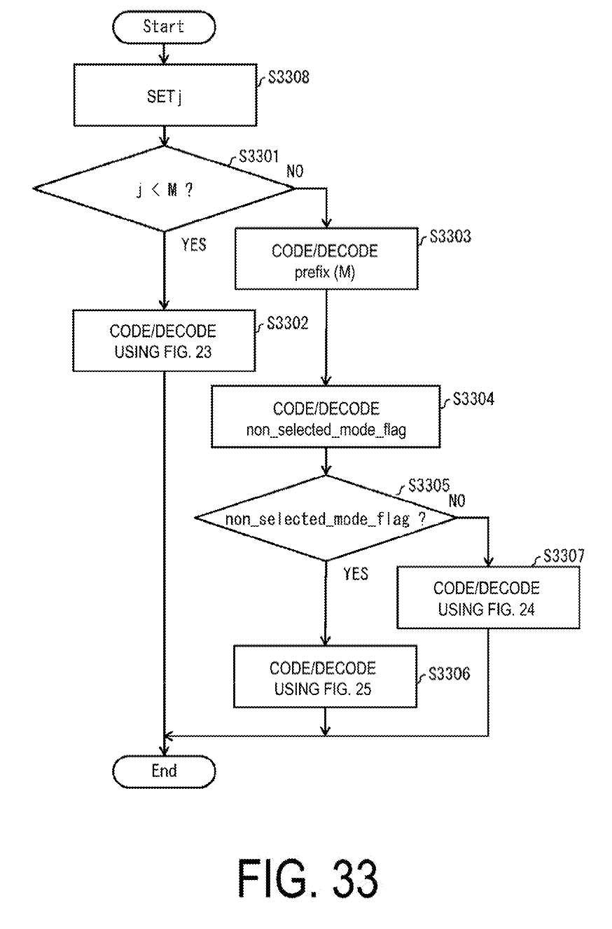

A flowchart describing an operation where the entropy coding unit 104 and the entropy decoding unit 301 codes/decodes intra prediction modes in the list is illustrated in FIG. 33. The entropy coding unit 104 sets the position i on each list of the intra prediction mode to the j in S3308. The entropy decoding unit 301 reads ahead the coded data, sets the number of “1” before “0” appears in j, and in addition, adds 1 in S3308. The operation to count the number of “1” before “0” appears by reading ahead is the same as Embodiment 1. S3301, whether j is less than M is determined. In a case of being less than M (YES in S3301), the operation advances to S3302. In a case of being not less than M (NO in S3301), the operation advances to S3303. In S3302, any of the MPM of M pieces is coded/decoded using FIG. 23, and the processing is finished. In S3303, the prefix M is coded decoded using FIG. 30. In S3304, non_selected_mode_flag is coded/decoded. In S3305, in a case that non_selected_mode_flag is not 0 (YES in S3305), the operation advances to S3306. In a case that non_selected_mode_flag is 0 (NO in S3305), the operation advances to S3307. In S3306, any of the remaining intra prediction modes of the smode list is coded/decoded using FIG. 25, and the processing is finished. At this time, the code of FIG. 25 corresponding to the number of subtracting M from rem_non_selected_mode is used. In S3307, rem_selected_mode is coded/decoded using FIG. 24, and the processing is finished.

Note that, although the entropy decoding unit 301 reads ahead the coded data in S3308 in the above, the operation is not limited to this, and the entropy decoding unit 301 may decode the coded data. In that case, the decoding of the MPM in S3302 and the decoding of the prefix in S3303 are not performed.

### Embodiment 3

As an embodiment not to code prev_intra_luma_pred_flag, another method to insert non_selected_mode_flag in the middle of the code will be described. In Embodiment 2, there is a problem that the longest code length becomes 13 bits (in a case that smode is equal to 25 to 50), and is too long for the length of a single code. Thus, the number of MPM coded at the beginning (the number of MPM which does not code non_selected_mode_flag) is reduced. The MPM is divided into two to be coded/decoded using different code tables, and non_selected_mode_flag can be placed forward in the code. In other words, since the code length of the prefix can be shortened, the longest code length can be shortened. That syntax is illustrated as follows.

smode
if (smode == M1)

non_selected_mode_flag
if (non_selected_mode_flag) {

smode

}
else {

rem_selected_mode

}

}

Moreover, an operation of an encoder may be also as follows.

if (i < M1) {

smode

}
else {

Prefix (M1)
non_selected_mode_flag
if (non_selected_mode_flag) {

smode

}
else {

rem_selected_mode

}

}

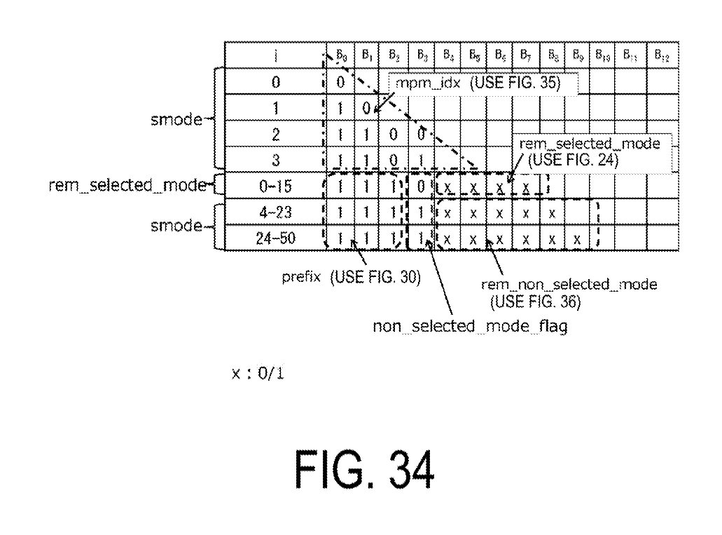

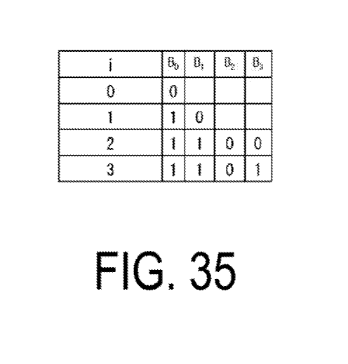

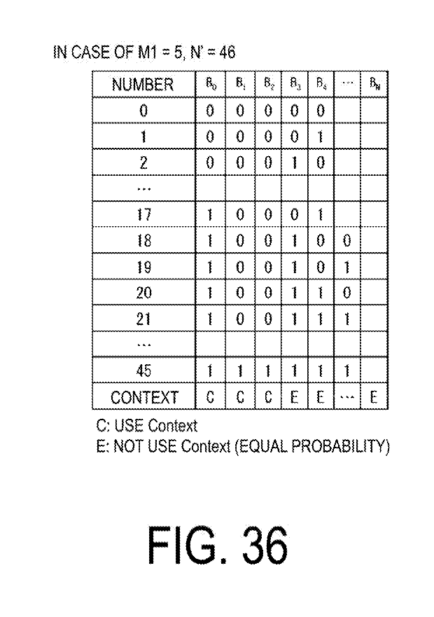

A specific example of the syntax is illustrated in FIG. 34. In a case that the position i on the list of the intra prediction modes is any of the MPM of M1 (M1 is greater than M (M1<M)) pieces being at the beginning of the smode list, the entropy coding unit 104 codes smode using the table of FIG. 35 without coding non_selected_mode_flag. Other than that, non_selected_mode_flag is coded after the prefix indicating the M1 in FIG. 30 is coded. In a case of not selected_mode, any of the M1-th intra prediction mode and subsequent intra prediction modes in the smode list is coded using FIG. 36. At this time, the code of FIG. 36 corresponding to the number of subtracting M from rem_non_selected_mode is used. In a case of selected_mode, any of the intra prediction modes in rem_selected_mode list is coded using FIG. 24. The entropy decoding unit 301 also decodes coded data in a similar procedure. However, in the entropy decoding unit 301, i is the value of adding 1 to the number of “1” before “0” appears similarly to Embodiment 2.

The code length of the prefix shortens by reducing the number of MPMs which does not code non_selected_mode_flag. The code length that is 13 bits in FIG. 32 is 10 bits in FIG. 34, and the longest code can be shortened.

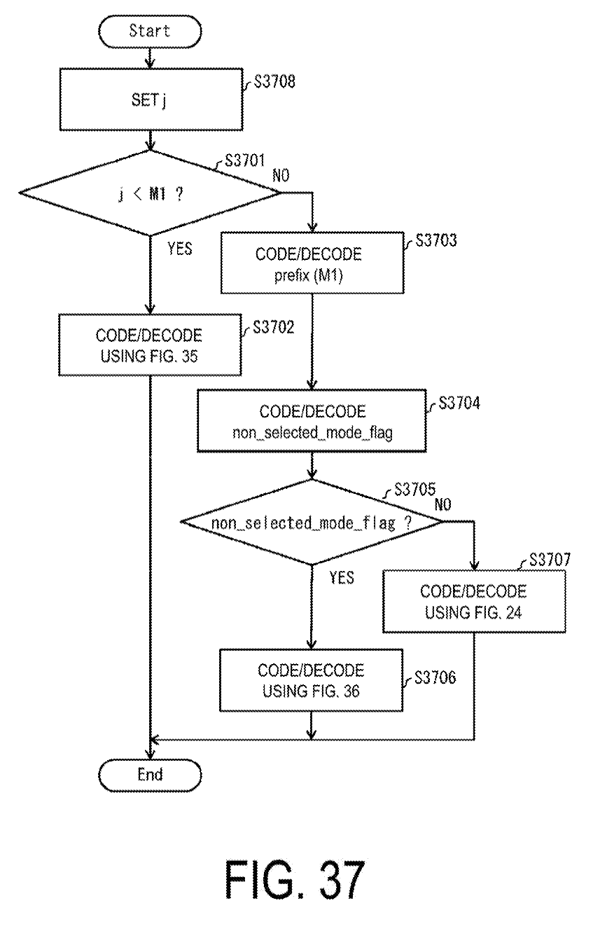

A flowchart describing an operation where the entropy coding unit 104 and the entropy decoding unit 301 codes/decodes intra prediction modes is illustrated in FIG. 37. The entropy coding unit 104 and the entropy decoding unit 301 set j in S3708. In S3701, whether j is less than M1 is determined. In a case of being less than M1 (YES in S3701), the operation advances to S3702. In a case of being not less than M1 (NO in S3701), the operation advances to S3703. In S3702, any of the MPM of M1 pieces is coded/decoded using FIG. 35, and the processing is finished. In S3703, the prefix M1 is coded/decoded using FIG. 30. In S3704, non_selected_mode_flag is coded/decoded. In S3705, whether non_selected_mode_flag is 0 is determined, and in a case of 0 (YES in S3705), the operation advances to S3706. In a case that non_selected_mode_flag is 0 (NO in S3705), the operation advances to S3707. In S3706, any of the remaining intra prediction modes of the smode list is coded/decoded using FIG. 36, and the processing is finished. In S3707, rem_selected_mode is coded/decoded using FIG. 24, and the processing is finished.

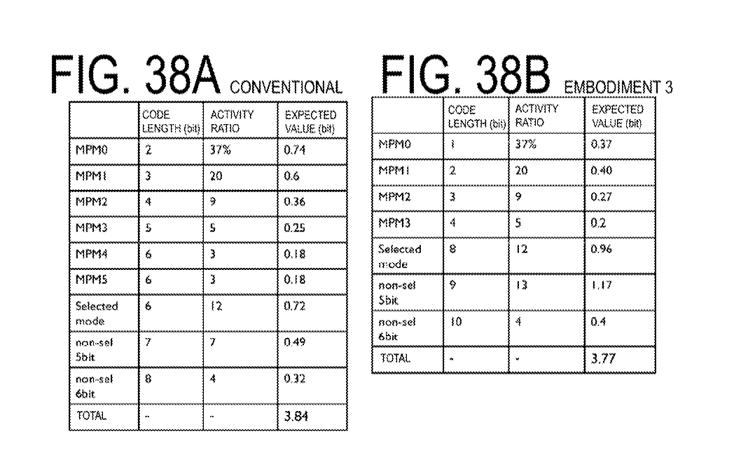

Note that, although the entropy decoding unit 301 reads ahead the coded data in S3708 in the above, the operation is not limited to this, and the entropy decoding unit 301 may decode the coded data. In that case, the decoding of the MPM in S3702 and the decoding of the prefix in S3703 are not performed. FIG. 38 is a table comparing expected values of the code lengths by Embodiment 3 with expected values of the code lengths by a conventional example, FIG. 38A is expected values of the code lengths per one code word in a case of using the codes of the conventional example, and FIG. 38B is expected values of the code lengths per one code word in a case of using codes of Embodiment 3. Usage ratios are calculated based on frequencies that MPM, rem_selected_mode (0 to 15), and rem_non_selected_mode (0 to 44) appear in the conditions same as FIG. 26. From FIGS. 38A and 38B, by coding with the method of Embodiment 3, the expected value 1 of the code length is found to be reduced 0.07 bits.

In the above, binarization in a case of processing the intra prediction modes with entropy coding/decoding has been described. From here, the creation method of the list used for the estimation of the intra prediction modes will be described.

### Embodiment 4

In the above-mentioned embodiment, the intra prediction mode is coded/decoded using the smode list storing rem_non_selected_mode after the MPM candidate list. In this embodiment, the creation method of the smode list will be described.

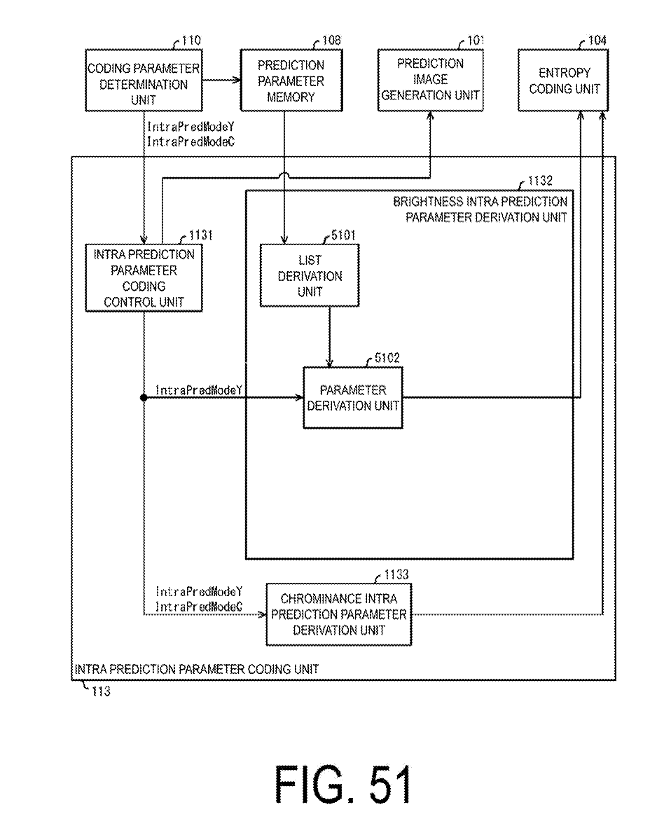

FIG. 51 is a schematic diagram illustrating a configuration of the intra prediction parameter coding unit 113 of the prediction parameter coding unit 111 of the image coding apparatus 11 illustrated in FIG. 6. Among components of FIG. 51, boxes having functions same as FIG. 15 are attached numbers that are the same as FIG. 15 and the descriptions are omitted.

The luminance intra prediction parameter derivation unit 1132 is configured to include a list derivation unit 5101 and a parameter derivation unit 5102.

The list derivation unit 5101 receives supply of prediction parameters stored by the prediction parameter memory 108. The list derivation unit 5101 supplies the smode list smodeList to the parameter derivation unit 5102.

The parameter derivation unit 5102 supplies smode, rem_sorted_mode, non_selected_mode_flag, and the like to the entropy coding unit 104.

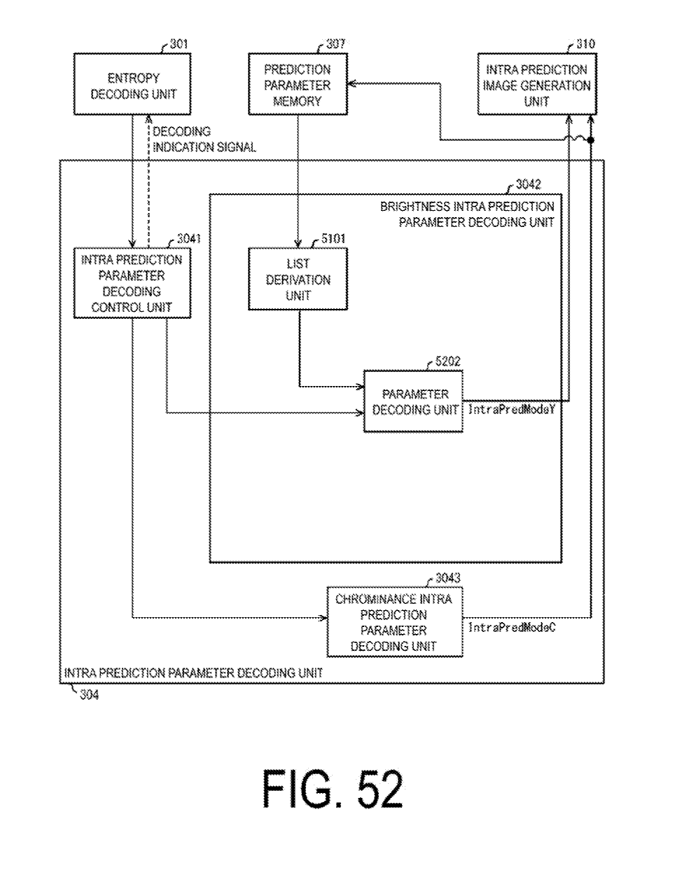

FIG. 52 is a schematic diagram illustrating a configuration of the intra prediction parameter decoding unit 304 of the prediction parameter decoding unit 302 of the image decoding apparatus 31 illustrated in FIG. 5. Among components of FIG. 52, boxes having functions same as FIG. 16 and FIG. 51 are attached numbers same as FIG. 16 and FIG. 51, and the descriptions are omitted.

The luminance intra prediction parameter decoding unit 3042 is configured to include the list derivation unit 5101 and a parameter decoding unit 5202.

The list derivation unit 5101 receives supply of prediction parameters stored by the prediction parameter memory 307. The list derivation unit 5101 supplies the smode list smodeList to the parameter decoding unit 5202.

The parameter decoding unit 5202 supplies the above-mentioned luminance prediction mode IntraPredModeY to the intra prediction image generation unit 310.

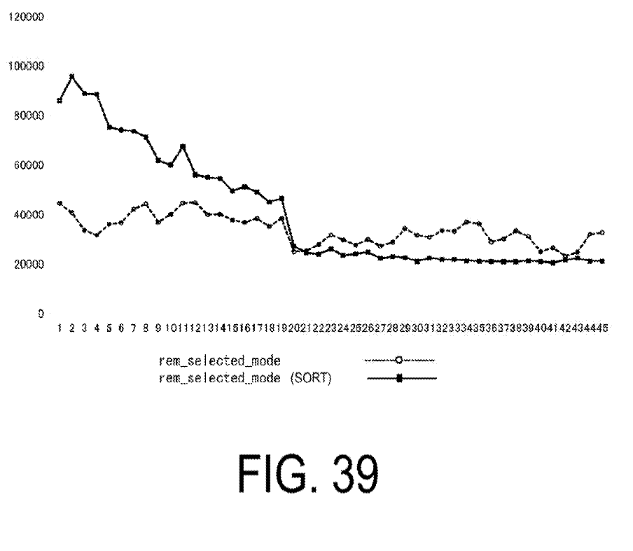

The intra prediction modes stored by the MPM candidate list are prioritized by priority order (occurrence frequency). However, conventional rem_non_selected_mode numbers in order intra prediction modes from intra prediction mode 2 of the bottom left direction to intra prediction mode 66 of the upper right direction other than MPM and rem_selected_mode as illustrated in FIG. 12. FIG. 39 is a graph representing occurrence frequencies of rem_non_selected_mode (0 to 44). The dotted line is conventional rem_non_selected_mode, and the solid line is rem_non_selected_mode rearranged (sorted) based on the distances with MPM nearest each intra prediction mode. From FIG. 39, although conventional rem_non_selected_mode is numbered regardless of occurrence frequencies, it is understood there is bias in the occurrence frequencies. rem_non_selected_mode used in Embodiment 1 to 3 is variable length coded, and can reduce a code amount to assign to rem_non_selected_mode and improve coding efficiency by assigning rem_non_selected_mode appearing frequently to shorter codes.

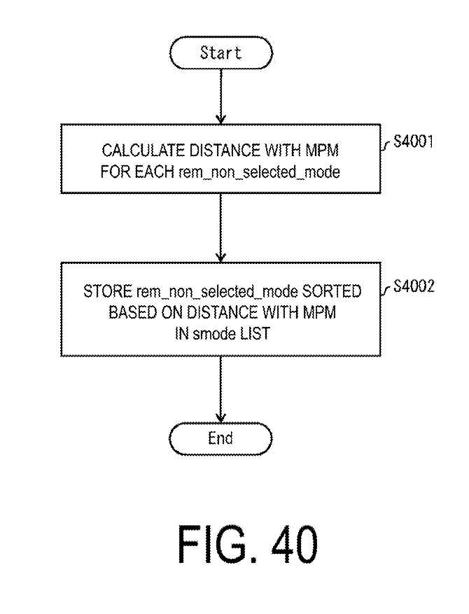

FIG. 40 illustrates a flowchart that the list derivation unit 5101 rearranges intra prediction modes categorized into rem_non_selected_mode and, based on the distances with MPM nearest each intra prediction mode, stores in the smode list. The list derivation unit 5101 calculates intra prediction modes categorized into rem_non_selected_mode and the distances with MPM nearest the rem_non_selected_mode in S4001. In S4002, rem_non_selected_mode sorted is stored sequentially in the smode list after having stored MPM from intra prediction modes having shorter distances calculated.

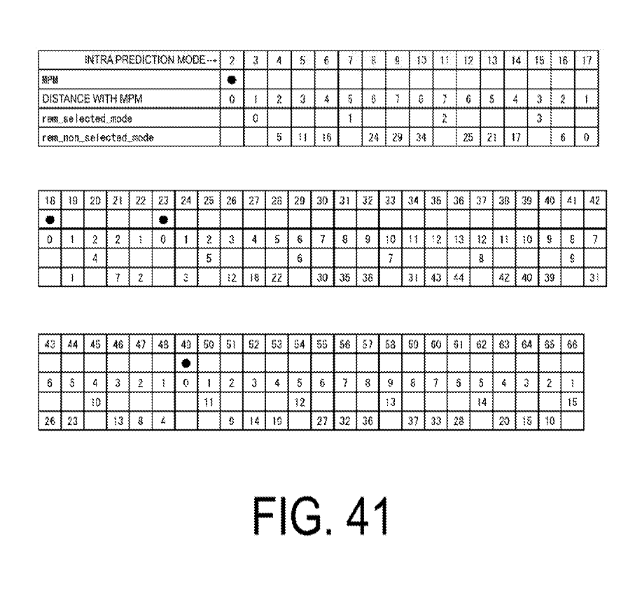

FIG. 41 is a table assigning numbers in order of rem_non_selected_mode from the intra prediction modes having the shortest distance with MPM, in intra prediction modes, the distances with MPM nearest them, and intra prediction modes categorized into rem_non_selected_mode, in a case that MPM is {49, 23, 0, 1, 2, 18} and rem_selected_mode is {3, 7, 11, 15, 20, 25, 29, 33, 37, 41, 45, 50, 54, 58, 62, 66}.

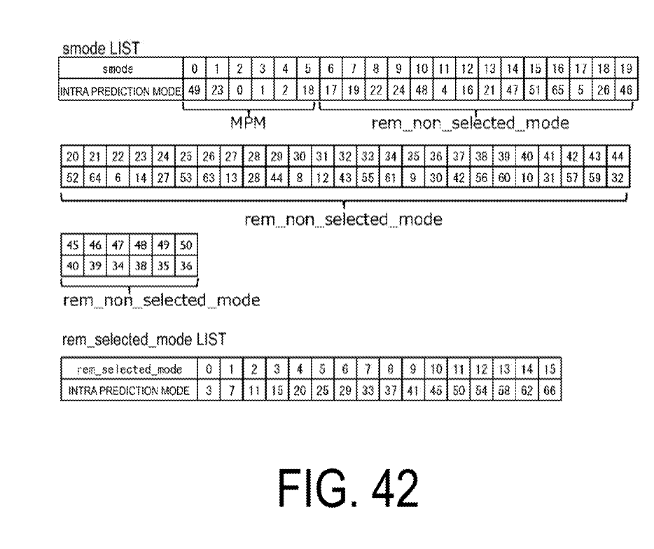

FIG. 42 illustrates the result of having stored the intra prediction modes indicated the numbers of rem_non_selected_mode associated in FIG. 41, in the smode list from those having smaller numbers sequentially. For example, in FIG. 42, the number 6 of the smode list corresponds to rem_non_selected_mode being 0 of FIG. 41, and similarly, the numbers 7, 8, 9, . . . of the smode list correspond to the numbers 1, 2, 3, . . . of rem_non_selected_mode. Note that intra prediction modes categorized into rem_selected_mode and the numbers thereof are described in FIG. 42.

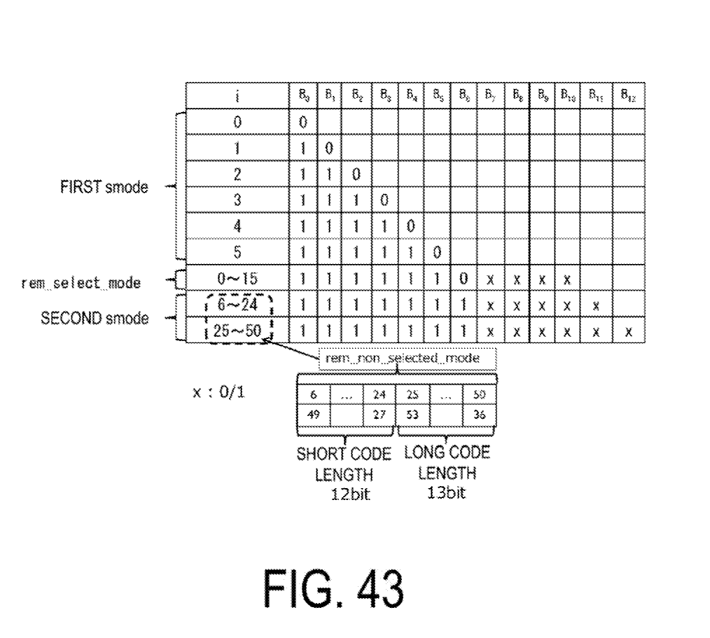

FIG. 43 is an example indicating the code at the position i of the intra prediction mode in the list. The code lengths increase in order of the first M1 pieces of the smode list (referred to as the first smode), the rem_selected_mode list (0 to 15), and the remaining (N-2^{P}-M1) pieces of the smode list (referred to as the second smode). Here, smode having shorter code lengths than rem_selected_mode is referred to as the first smode, and smode having longer code lengths than rem_selected_mode is referred to as the second smode. There are long codes and short codes in the second smode, and 19 intra prediction modes of i=6 to 24 are assigned to short codes. These are intra prediction modes which relatively appear frequently in the smode list, for example, in the example of FIG. 42, smode=6 to 24 (the corresponding intra prediction modes are 17 to 27). 26 intra prediction modes of i=25 to 50 are assigned to long codes. These are intra prediction modes which appear less frequently in the smode list, for example, in the example of FIG. 42, smode=25 to 50 (the corresponding intra prediction modes are 53 to 36).

Thus, the list derivation unit 5101 stores intra prediction modes in the smode list in the order of the frequency of appearance by sorting rem_non_selected_mode. Thereby, by being able to assign short codes to intra prediction modes appearing frequently also in rem_non_selected_mode, coding efficiency can be improved.

However, in the second smode, since coding efficiency does not improve even in a case of sorting intra prediction modes having long code lengths (in FIGS. 42 and 43, smode=25 to 50) in an occurrence frequency order, sorting may be omitted from a point of throughput reduction.

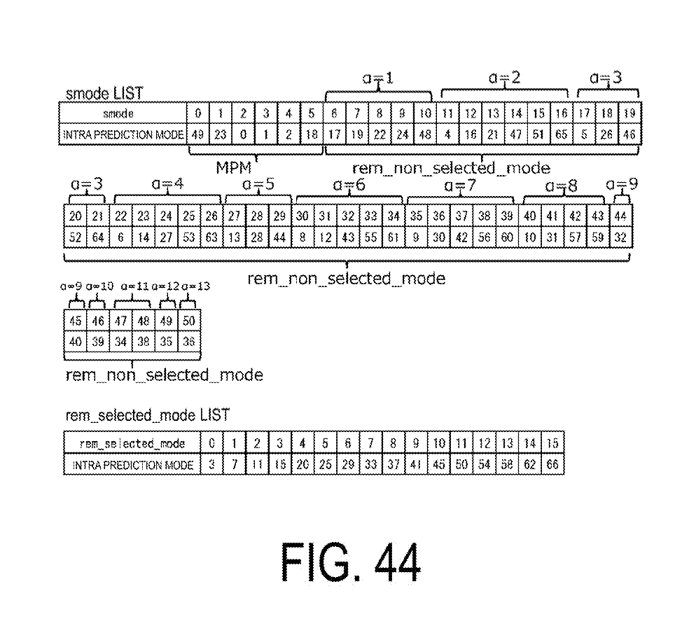

Note that, although the smode list is created based on intra prediction modes and distances with MPM nearest to the intra prediction modes in Embodiment 4, this can be expressed in other words as an extension (extended derived mode) of the derived mode (MPM±1) used at the time of the MPM candidate list creation, as equivalent to expressing intra prediction modes categorized into rem_non_selected_mode with MPM=α (α=1, 2, 3, . . . ) and storing the intra prediction modes in the smode list, in the order from an intra prediction mode with smaller α. Therefore, the smode list of FIG. 42 can be expressed in other words as storing the extended derived mode MPM±α after the neighboring mode and the plane mode. In other words, the smode list can be created without using a concept of rem_non_selected_mode. FIG. 44 is an example expressing the smode list of FIG. 42 as the extended derived mode.

### Embodiment 5

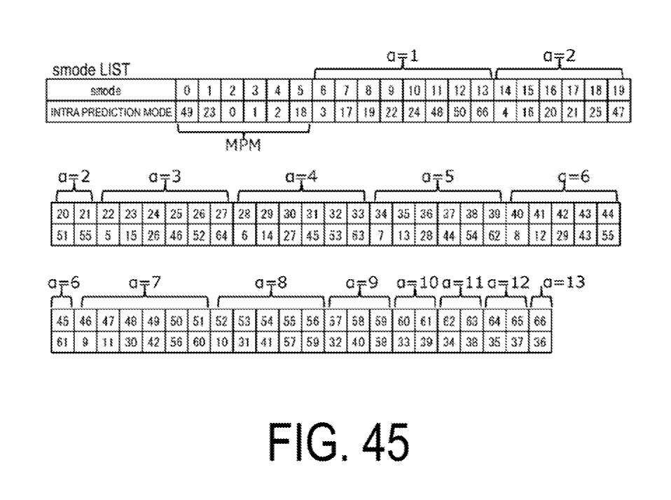

In Embodiment 4, a technique to code by categorizing intra prediction modes in the smode list (neighboring mode, plane mode, extended derived mode) and rem_selected_mode has been described. In this embodiment, a technique to express all into prediction modes other than the neighboring mode and the plane mode as an extended derived mode (MPM±α) and fixed length code a part without rem_selected_mode is described. FIG. 45 is an example to store in the smode list from intra prediction modes having smaller distances with MPM sequentially regardless of rem_selected_mode and rem_non_selected_mode in FIG. 41. The syntax of specific codes can be expressed using any of FIG. 22, FIG. 23, and FIG. 32.

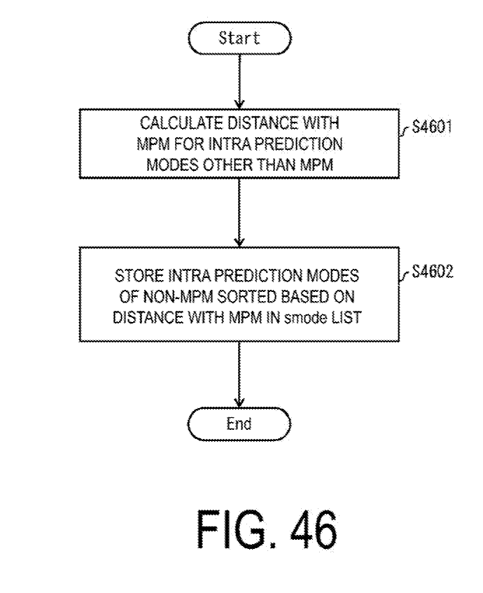

FIG. 46 is a flowchart describing an operation where the list derivation unit 5101 creates the smode list. The list derivation unit 5101 calculates distances with MPM for intra prediction modes other than MPM an S4601. In S4602, intra prediction modes of non-MPM sorted based on distances with MPM are stored in order in the smode list.

Note that the target of variable length coding may be intra prediction modes of 2^{P} pieces right after MPM, or may intra prediction modes of 2^{P} pieces q pieces spaced-apart from the position after MPM.

Note that the list derivation unit 5101 may create the smode list without calculating distances with intra prediction modes and MPM. Specifically, intra prediction modes of ±1, ±2, ±3, . . . , ±N are stored in the smode list to each MPM. At this time, the intra prediction modes stored in the smode list are not stored anymore. Note that in a case of describing with ±α, they may be stored in order of +α, −α, or may be stored in order of −α, +α. In this approach, sorting of intra prediction modes is also not necessary.

According to the above configuration, by also sorting intra prediction modes other than MPM based on distances with MPM, intra prediction modes can be coded based on occurrence probability, and coding efficiency improves.

In this way, by not distinguishing whether or not selected_mode (rem_selected_mode and rem_non_selected_mode), it becomes easier to sort intra prediction modes based on the distances with MPM and store into the smode list.

In a case of storing intra prediction modes of ±1, ±2, ±3, . . . , ±N in the smode list to each MPM, by not distinguishing whether or not selected_mode, processing can be simplified.

### Embodiment 6

In the present application, a technique for the purpose of coding efficiency improvement by introducing the smode list, based on increase of intra prediction modes by QTBT split and changes of occurrence frequencies has been described. In this embodiment, a coding method of intra prediction modes suitable for various block sizes and quantization step sizes of QTBT split will be described.

As sizes of CU or PU become larger, prediction precision can be improved by increasing the number of directional predictions. However, for example, in a case of CU or PU of small sizes such as 4×4, or a blur image with large quantization step sizes, prediction precision does not improve even by increasing intra prediction modes. Thus, in this embodiment, coding efficiency improves by being capable of varying the number of intra prediction modes of non-MPM depending on sizes of CU and PU, and quantization step sizes. Syntax for being capable of varying the number of intra prediction modes of non-MPM depending on block sizes arid quantization step sizes is illustrated below.

A Case of Being Capable of Varying the Number of Intra Prediction
Modes of Non-MPM
Depending on Sizes
delta_alpha = 1
if (BLKSize <= TH1) {

P = P−1 /* P is the bit number of fixed length codes */
delta_alpha = delta_alpha + 1

}
A Case of Being Capable of Varying the Number of Intra Prediction
Modes of Non-MPM
Depending on Quantization Step Sizes
delta_alpha = 1
if (QP >= TH2) {

P = P−1 /* P is the bit number of fixed length codes */
delta_alpha = delta_alpha + 1

}

Here, delta_alpha is an increment of the parameter α of the extended derived mode described in Embodiment 5. Moreover, P is the bit number of fixed length codes. In a case that delta_alpha is 1, intra prediction modes of MPM±1, ±2, ±3, . . . , ±N are stored in the smode list, and in a case that delta_alpha is 2, intra prediction modes of MPM±2, ±4, ±6, ±2×N are stored in the smode list. In a case of deriving distances with MPM, in a case that delta_alpha is 1, intra prediction modes where distances with MPM are 1, 2, 3, . . . , N are stored in the smode list, and in a case that delta_alpha is 2, intra prediction modes where distances with MPM are 2, 4, 6, . . . , 2×N are stored in the smode list.

Although the syntax is an example resetting the bit number P of fixed length codes and the increment of α delta_alpha together under a certain condition, only either P or delta_alpha may be reset.

By selecting α in this way, in a case that BLKSize is equal to or smaller than TH1 (BLKSize<=TH1) or QP is equal to or larger than TH2 (QP>=TH2), the number of rem_non_selected_mode of Embodiment 4 becomes about half.

A configuration to change P depending on sizes and quantization step sizes of CU and PU, and to reduce the number of rem_selected_mode is also possible. For example, in FIG. 45, by assigning only 8 pieces of smode (14 to 21, intra prediction modes are 4 to 55) of α being 2 (α=2) to fixed length codes, the number of intra prediction modes assigned to fixed length codes can be 8 pieces in a case that BLKSize is equal to or smaller than TH1 (BLKSize<=TH1) or QP is equal to or larger than TH2 (QP>=TH2), or can be 16 pieces otherwise. In other words, the number of rem_selected_mode Embodiment 4 can be almost half.

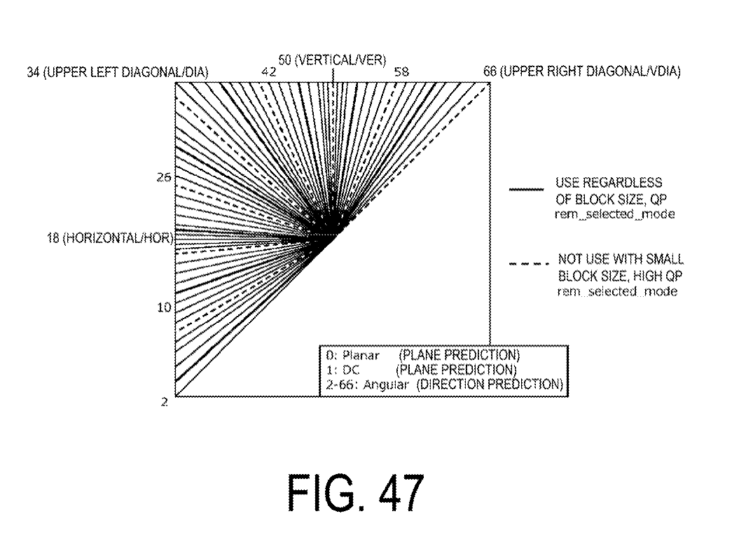

Another configuration to reduce the number of rem_selected_mode depending on sizes and quantization step sizes of CU and PU is also possible. For example, FIG. 44 is an example managing selected_mode and non-selected_mode in separate lists. In a case that BLKSize is equal to or smaller than TH1 (BLKSize<=TH1) or QP is equal to or larger than TH2 (QP>=TH2), intra prediction modes assigned to fixed length codes are 8 pieces of rem_selected_mode=2×C (C=0, 1, 2 . . . ) of FIG. 44. Otherwise, intra prediction modes are assigned to 16 pieces of all rem_selected_mode of FIG. 44. Among rem_selected_mode of FIG. 44, rem_selected_mode used regardless of sizes and quantization step sizes QP of CU and PU is illustrated with the solid line of FIG. 47, and rem_selected_mode not used in a case that CU and PU are small sizes and quantization step sizes QP are high is illustrated with the dashed line.

In a case of being used with the configuration of Embodiment 4 or the configuration of Embodiment 5, the syntax can reduce the number of rem_selected_mode depending on block sizes and quantization step sizes of CU or PU. In this case, the number of rem_selected_mode of Embodiment 4 and Embodiment 5 becomes half.

Although the numbers are controlled separately for rem_non_selected_mode and rem_selected_mode in the above-mentioned example, the number may be controlled together.

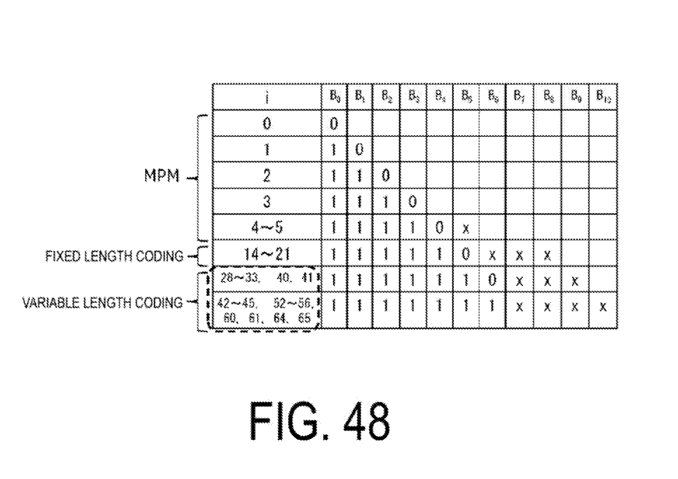

FIG. 48 is a coding example reducing the number of intra prediction modes to half. In a case that the smode list is of FIG. 45, MPM of FIG. 48 is the first 6 MPM of the smode list. Fixed length codes of FIG. 48 are 8 pieces of the intra prediction modes described with α=2 (MPM±2) of FIG. 45. Variable length codes of FIG. 48 are 21 pieces of intra prediction modes described with α=4, 6, 8, 10, 12 (MPM±α) of FIG. 45.

Alternatively, the smode list can be applied to FIG. 44. In this case, MPM of FIG. 48 is the first 6 MPM of the smode list. The fixed length codes of FIG. 48 are 8 pieces at the places with even numbers among the intra prediction modes described in the rem_selected_mode list of FIG. 44. The variable length codes of FIG. 48 are the intra prediction modes described with α=2, 4, 6, 8, 10, 12 (MPM±α) among the smode lists of FIG. 44.

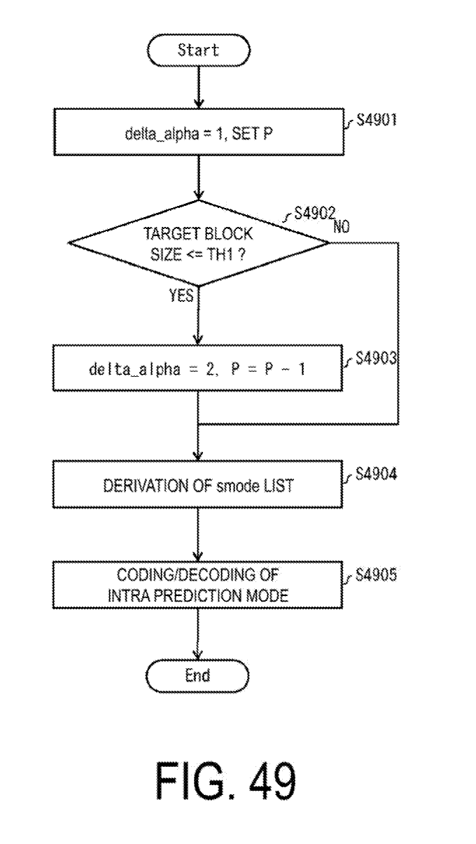

FIG. 49 is a flowchart describing an operation where the list derivation unit 5101, the entropy coding unit 104, and the entropy decoding unit 301 change the number of intra prediction modes depending on sizes of CU or PU. The list derivation unit 5101 initializes the increment of α delta_alpha and P in S4901. In S4902, whether the size of the target CU or PU is a prescribed threshold or less is determined, and in a case of the threshold or less (YES in S4902), the operation advances to S4903, or otherwise (NO in S4902) the operation advances to S4904. In S4903, the increment of α delta_alpha and P are set again. In S4904, the smode list is created using set delta_alpha and P. Specifically, the methods described with Embodiments 4 or 5 are used. The entropy coding unit 104 and the entropy decoding unit 301 code/decode intra prediction modes using the smode list in S4905.

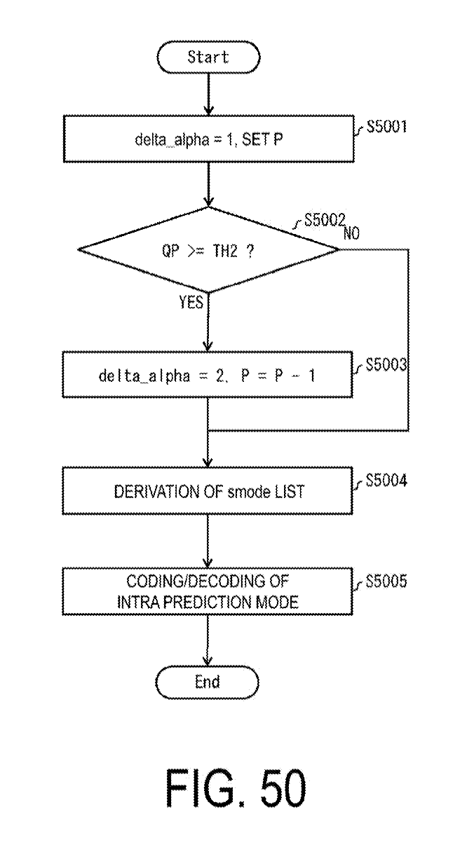

FIG. 50 is a flowchart describing an operation where the list derivation unit 5101, the entropy coding unit 104, and the entropy decoding unit 301 change the number of intra prediction modes depending on quantization step sizes of CU or PU. The list derivation unit 5101 initializes the increment of α delta_alpha and P in S5001. In S5002, whether the quantization step size QP of the target CU or PU is a prescribed threshold or more is determined, and in a case of threshold or more (YES in S5002), the operation advances to S5003, or otherwise (NO in S5002), the operation advances to S5004. In S5003, the increment of α delta_alpha and P are set again. In S5004, the smode list is created using set delta_alpha and P. Specifically, the methods described with Embodiments 4 or 5 are used. The entropy coding unit 104 and the entropy decoding unit 301 code/decode intra prediction modes using the smode list in S5005.

Thus, by increasing and decreasing the number of intra prediction modes used depending on block sizes and quantization step sizes, coding efficiency can be improved since a code amount to assign to intra prediction modes can be reduced without affecting prediction precision.

### Others

Note that, part of the image coding apparatus 11 and the image decoding apparatus 31 in the above-mentioned embodiments, for example, the entropy decoding unit 301, the prediction parameter decoding unit 302, the loop filter 305, the prediction image generation unit 308, the inverse quantization and inverse DCT unit 311, the addition unit 312, the prediction image generation unit 101, the subtraction unit 102, the DCT and quantization unit 103, the entropy coding unit 104, the inverse quantization and inverse DCT unit 105, the loop filter 107, the coding parameter determination unit 110, the prediction parameter coding unit 111, and blocks included by each unit may be realized by a computer. In that case, this configuration may be realized by recording a program for realizing such control functions on a computer-readable recording medium and causing a computer system to read the program recorded on the recording medium for execution. Note that it is assumed that the “computer system” mentioned here refers to a computer system built into either the image coding apparatus 11 or the image decoding apparatus 31, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system. Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Part or all of the image coding apparatus 11 and the image decoding apparatus 31 in the above-described embodiments may be realized as an integrated circuit such as a Large Scale Integration (LSI). Each function block of the image coding apparatus 11 and the image decoding apparatus 31 may be individually realized as processors, or part or all may be integrated into processors. The circuit integration technique is not limited to LSI, and the integrated circuits for the functional blocks may be realized as dedicated circuits or a multi-purpose processor. Furthermore, in a case where with advances in semiconductor technology, a circuit integration technology with which an LSI is replaced appears, an integrated circuit based on the technology may be used.

### Application Examples

The above-mentioned image coding apparatus 11 and the image decoding apparatus 31 can be utilized being installed to various apparatuses performing transmission, reception, recording, and regeneration of videos. Note that, videos may be natural videos imaged by cameras or the like, or may be artificial videos (including CG and GUI) generated by computers or the like.

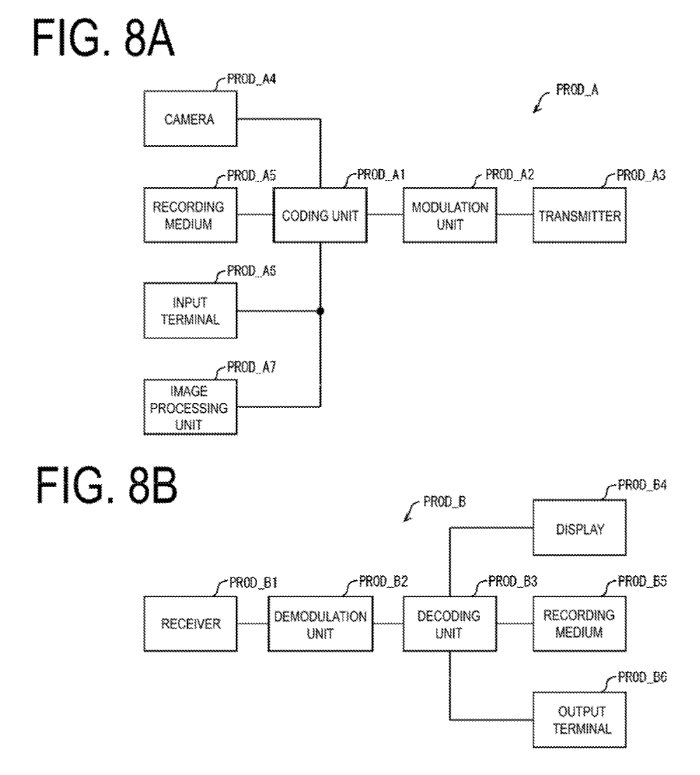

At first, referring to FIGS. 8A and 8B, it will be described that the above-mentioned image coding apparatus 11 and the image decoding apparatus 31 can be utilized for transmission and reception of videos.

FIG. 8A is a block diagram illustrating a configuration of a transmitting apparatus PROD_A installed with the image coding apparatus 11. As illustrated in FIG. 8A, the transmitting apparatus PROD_A includes a coding unit PROD_A1 which obtains coded data by coding videos, a modulation unit PROD_A2 which obtains modulating signals by modulating carrier waves with the coded data obtained by the coding unit PROD_A1, and a transmitter PROD_A3 which transmits the modulating signals obtained by the modulation unit PROD_A2. The above-mentioned image coding apparatus 11 is utilized as the coding unit PROD_A1.

The transmitting apparatus PROD_A may further include a camera PROD_A4 imaging videos, a recording medium PROD_A5 recording videos, an input terminal PROD_A6 to input videos from the outside, and an image processing unit A7 which generates or processes images, as sources of supply of the videos input into the coding unit PROD_A1. In FIG. 8A, although the configuration that the transmitting apparatus PROD_A includes these all is exemplified, a part may be omitted.

Note that the recording medium PROD_A5 may record videos which are not coded or may record videos coded in a coding scheme for record different than a coding scheme for transmission. In the latter case, a decoding unit (not illustrated) to decode coded data read from the recording medium PROD_A5 according to coding scheme for recording may be interleaved between the recording medium PROD_A5 and the coding unit PROD_A1.

FIG. 8B is a block diagram illustrating a configuration of a receiving apparatus PROD_B installed with the image decoding apparatus 31. As illustrated in FIG. 8B, the receiving apparatus PROD_B includes a receiver PROD_B1 which receives modulating signals, a demodulation unit PROD_B2 which obtains coded data by demodulating the modulating signals received by the receiver PROD_B1, and a decoding unit PROD_B3 which obtains videos by decoding the coded data obtained by the demodulation unit PROD_B2. The above-mentioned image decoding apparatus 31 is utilized as the decoding unit PROD_B3.

The receiving apparatus PROD_B may further include a display PROD_B4 displaying videos, a recording medium PROD_B5 to record the videos, and an output terminal PROD_B6 to output videos outside, as supply destination of the videos output by the decoding unit PROD_B3. In FIG. 8B, although the configuration that the receiving apparatus PROD_B includes these all is exemplified, a part may be omitted.

Note that the recording medium PROD_B5 may record videos which are not coded, or may record videos which are coded in a coding scheme different from a coding scheme for transmission. In the latter case, a coding unit (not illustrated) to code videos acquired from the decoding unit PROD_B3 according to a coding scheme for recording may be interleaved between the decoding unit PROD_B3 and the recording medium PROD_B5.

Note that the transmission medium transmitting modulating signals may be wireless or may be wired. The transmission aspect to transmit modulating signals may be broadcasting (here, referred to as the transmission aspect where the transmission target is not specified beforehand) or may be telecommunication (here, referred to as the transmission aspect that the transmission target is specified beforehand). Thus, the transmission of the modulating signals may be realized by any of radio broadcasting, cable broadcasting, radio communication, and cable communication.

For example, broadcasting stations (broadcasting equipment, and the like)/receiving stations (television receivers, and the like) of digital terrestrial television broadcasting is an example of transmitting apparatus PROD_A/receiving apparatus PROD_B transmitting and/or receiving modulating signals in radio broadcasting. Broadcasting stations (broadcasting equipment, and the like stations (television receivers, and the like) of cable television broadcasting are an example of transmitting apparatus PROD_A/receiving apparatus PROD_B transmitting and/or receiving modulating signals in cable broadcasting.

Servers (work stations, and the like)/clients (television receivers, personal computers, smartphones, and the like) for Video On Demand (VOD) services, video hosting services using the Internet and the like are an example of transmitting apparatus PROD_A/receiving apparatus PROD_B transmitting and/or receiving modulating signals in telecommunication (usually, any of radio or cable is used as transmission medium in the LAN, and cable is used for as transmission medium in the WAN). Here, personal computers include a desktop PC, a laptop type PC, and a graphics tablet type PC. Smartphones also include a multifunctional portable telephone terminal.

Note that a client of a video hosting service has a function to code a video imaged with a camera and upload the video to a server, in addition to a function to decode coded data downloaded from a server and to display on a display. Thus, a client of a video hosting service functions as both the transmitting apparatus PROD_A and the receiving apparatus PROD_B.

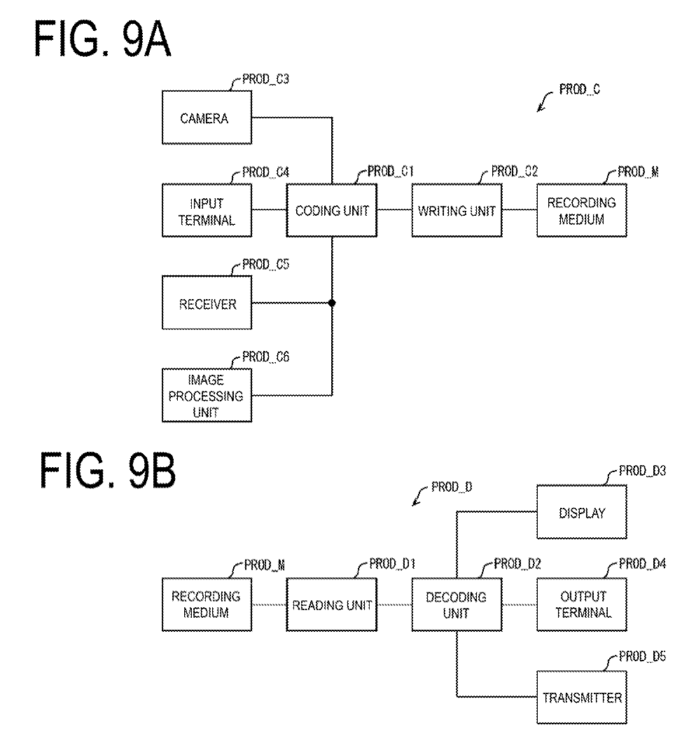

Next, referring to FIGS. 9A and 9B, it will be described that the above-mentioned image coding apparatus 11 and the image decoding apparatus 31 can be utilized for recording and regeneration of videos.

FIG. 9A is a block diagram illustrating a configuration of a recording apparatus PROD_C installed with the above-mentioned image coding apparatus 11. As illustrated in FIG. 9A, the recording apparatus PROD_C includes a coding unit PROD_C1 which obtains coded data by coding a video, and a writing unit PROD_C2 which writes the coded data obtained by the coding unit PROD_C1 in a recording medium PROD_M. The above-mentioned image coding apparatus 11 is utilized as the coding unit PROD_C1.

Note that the recording medium PROD_M may be (1) a type built in the recording apparatus PROD_C such as Hard Disk Drive (HDD) or Solid State Drive (SSD), may be (2) a type connected to the recording apparatus PROD_C such as an SD memory card or a Universal Serial Bus (USB) flash memory, and may be (3) a type loaded in a drive apparatus (not illustrated) built in the recording apparatus PROD_C such as Digital Versatile Disc (DVD) or Blu-ray Disc (BD: trade name).

The recording apparatus PROD_C may further include a camera PROD_C3 imaging a video, an input terminal PROD_C4 to input the video from the outside, a receiver PROD_C5 to receive the video, and an image processing unit PROD_C6 which generates or processes images, as sources of supply of the video input into the coding unit PROD_C1. In FIG. 9A, although the configuration that the recording apparatus PROD_C includes these all is exemplified, a part may be omitted.

Note that the receiver PROD_C5 may receive a video which is not coded, or may receive coded data coded in a coding scheme for transmission different from a coding scheme for recording. In the latter case, a decoding unit (not illustrated) for transmission to decode coded data coded in a coding scheme for transmission may be interleaved between the receiver PROD_C5 and the coding unit PROD_C1.

Examples of such recording apparatus PROD_C include a DVD recorder, a BD recorder, a Hard Disk Drive (HDD) recorder, and the like (in this case, the input terminal PROD_C4 or the receiver PROD_C5 is the main source of supply of a video). A camcorder (in this case, the camera PROD_C3 is the main source of supply of a video), a personal computer (in this case, the receiver PROD_C5 or the image processing unit C6 is the main source of supply of a video), a smartphone (in this case, the camera PROD_C3 or the receiver PROD_C5 is the main source of supply of a video), or the like is an example of such recording apparatus PROD_C.

FIG. 9B is a block diagram illustrating a configuration of a regeneration apparatus PROD_D installed with the above-mentioned image decoding apparatus 31. As illustrated in FIG. 9B, the regeneration apparatus PROD_D includes a reading unit PROD_D1 which reads coded data written in the recording medium PROD_M, and a decoding unit PROD_D2 which obtains a video by decoding the coded data read by the reading unit PROD_D1. The above-mentioned image decoding apparatus 31 is utilized as the decoding unit PROD_D2.

Note that the recording medium PROD_M may be (1) a type built in the regeneration apparatus PROD_D such as HDD or SSD, may be (2) a type connected to the regeneration apparatus PROD_D such as an SD memory card or a USB flash memory, and may be (3) a type loaded in a drive apparatus (not illustrated) built in the regeneration apparatus PROD_D such as DVD or BD.

The regeneration apparatus PROD_D may further include a display PROD_D3 displaying a video, an output terminal PROD_D4 to output the video to the outside, and a transmitter PROD_D5 which transmits the video, as the supply destination of the video output by the decoding unit PROD_D2. In FIG. 9B, although the configuration that the regeneration apparatus PROD_D includes these all is exemplified, a part may be omitted.

Note that the transmitter PROD_D5 may transmit a video which is not coded, or may transmit coded data coded in a coding scheme for transmission different than a coding scheme for recording. In the latter case, a coding unit (not illustrated) to code a video in a coding scheme for transmission may be interleaved between the decoding unit PROD_D2 and the transmitter PROD_D5.

Examples of such regeneration apparatus PROD_D include a DVD player, a BD player, an HDD player, and the like (in this case, the output terminal PROD_D4 to which a television receiver, and the like is connected is the main supply target of the video). A television receiver (in this case, the display PROD_D3 is the main supply target of the video), a digital signage (also referred to as an electronic signboard or an electronic bulletin board, and the like, the display PROD_D3 or the transmitter PROD_D5 is the main supply target of the video), a desktop PC (in this case, the output terminal PROD_D4 or the transmitter PROD_D5 is the main supply target of the video), a laptop type or graphics tablet type PC (in this case, the display PROD_D3 or the transmitter PROD_D5 is the main supply target of the video), a smartphone (in this case, the display PROD_D3 or the transmitter PROD_D5 is the main supply target of the video), or the like is an example of such regeneration apparatus PROD_D.

### Realization as Hardware and Realization as Software

Each block of the above-mentioned image decoding apparatus 31 and the image coding apparatus 11 may be realized as a hardware by a logical circuit formed on an integrated circuit (IC chip), or may be realized as a software using Central Processing Unit (CPU).

In the latter case, each apparatus includes a CPU performing a command of a program to implement each function, a Read Only Memory (ROM) stored in the program, a Random Access Memory (RAM) developing the program, and a storage apparatus (recording medium) such as a memory storing the program and various data, and the like. The purpose of the embodiments of the present invention can be achieved by supplying, to each of the apparatuses, the recording medium recording readably the program code (execution term program, intermediate code program, source program) of the control program of each of the apparatuses which is a software implementing the above-mentioned functions with a computer, and reading and performing the program code that the computer (or a CPU or a MPU) records in the recording medium.

For example, as the recording medium, a tape such as a magnetic tape or a cassette tape, a disc including a magnetic disc such as a floppy (trade name) disk/a hard disks and an optical disc such as a Compact Disc Read-Only Memory (CD-ROM)/Magneto-Optical disc (MO disc)/Mini Disc (MD)/Digital Versatile Disc (DVD)/CD Recordable (CD-R)/Blu-ray Disc (trade name), a card such as an IC card (including a memory card)/an optical memory card, a semiconductor memory such as a mask ROM/Erasable Programmable Read-Only Memory (EPROM)/Electrically Erasable and Programmable Read-Only Memory (EEPROM: trade name)/a flash ROM, or a Logical circuits such as a Programmable logic device (PLD) or a Field Programmable Gate Array (FPGA) can be used.

Each of the apparatuses may be configured to be connectable to a communication network, and the program code may be supplied through the communication network. This communication network may be able to transmit a program code, and is not specifically limited. For example, the Internet, the intranet, the extranet, Local Area Network (LAN), Integrated Services Digital Network (ISDN), value-Added Network (VAN), a Community Antenna television/Cable Television (CATV) communication network, Virtual Private Network, telephone network, a mobile communication network, satellite communication network, and the like are available. A transmission medium constituting this communication network may also be a medium which can transmit a program code, and is not limited to a particular configuration or a type. For example, a cable communication such as institute of Electrical and Electronic Engineers (IEEE) 1394, a USB, a power line carrier, a cable TV line, a phone line, an Asymmetric Digital Subscriber Line (ADSL) line, and a radio communication such as infrared ray such as Infrared Data Association (IrDA) or a remote control, BlueTooth (trade name), IEEE 802.11 radio communication, High Data Rate (HDR), Near Field Communication (NFC), Digital Living Network Alliance (DLNA: trade name), a cellular telephone network, a satellite channel, a terrestrial digital broadcast network are available. Note that the embodiments of the present invention can be also realized in the form of computer data signals embedded in a carrier wave where the program code is embodied by electronic transmission.

### Supplemental Note

The embodiments of the present invention are not limited to the above-mentioned embodiments, and various modifications are possible within the scope of the claims. Thus, embodiments obtained by combining technical means modified appropriately within the scope defined by claims are included in the technical scope of the present invention.

### INDUSTRIAL APPLICABILITY

### CROSS-REFERENCE OF RELATED APPLICATION

This application claims the benefit of priority to JP 2016-202710 filed on Oct. 14, 2016, which is incorporated herein by reference in its entirety.

The embodiments of the present invention can be preferably applied to an image decoding apparatus to decode coded data where graphics data is coded, and an image coding apparatus to generate coded data where graphics data is coded. The embodiments of the present invention can be preferably applied to a data structure of coded data generated by the image coding apparatus and referred to by the image decoding apparatus.

### REFERENCE SIGNS LIST

11 Image coding apparatus
31 Image decoding apparatus
1131 Intra prediction parameter coding control unit
3041 Intra prediction parameter decoding control unit
5101 List derivation unit
5102 Parameter derivation unit
5202 Parameter decoding unit

1. An entropy coding apparatus for entropy coding an intra prediction mode used for an intra prediction of a target block, wherein
the intra prediction mode is classified in a first intra prediction mode using a variable length code and a second intra prediction mode using a fixed length code,
the entropy coding apparatus comprising:
a memory; and
a processor, wherein the processor configured to perform steps of:
coding a flag to indicate whether a target intra prediction mode is the first intra prediction mode or the second intra prediction mode;
coding in the first intra prediction mode to either code the first prediction mode, or code the first prediction mode after having coded a prefix; and
fixed length coding the second intra prediction mode.

2. The entropy coding apparatus according to claim 1, wherein
the entropy coding apparatus is configured to code the flag, and
then code the first intra prediction mode or the second intra prediction mode.

3. The entropy coding apparatus according to claim 1, wherein
the entropy coding apparatus is configured to fixed length code the second intra prediction mode after having coded the prefix.

4. The entropy coding apparatus according to claim 3, wherein
the entropy coding apparatus is configured to code the flag after having coded the prefix.

5. An entropy decoding apparatus for entropy decoding an intra prediction mode used for an intra prediction of a target block, wherein
the intra prediction mode is classified in a first intra prediction mode using a variable length code and a second intra prediction mode using a fixed length code,
the entropy decoding apparatus comprising:
a memory; and
a processor, wherein the processor configured to perform steps of:
decoding a flag to indicate whether a target intra prediction mode is the first intra prediction mode or the second intra prediction mode;
decoding in the first intra prediction mode to either decode the first prediction mode without decoding a prefix, or decode the first prediction mode after having decoded the prefix; and
fixed length decoding the second intra prediction mode.

6. The entropy decoding apparatus according to claim 5, wherein
the entropy decoding apparatus is configured to decode the flag, and
then decode the first intra prediction mode or the second intra prediction mode.

7. The entropy decoding apparatus according to claim 5, wherein
the entropy decoding apparatus is configured to fixed length decode the second intra prediction mode after having decoded the prefix.

8. The entropy decoding apparatus according to claim 7, wherein
the entropy decoding apparatus is configured to decode the flag after having decoded the prefix.

9. A decoding apparatus for performing an intra prediction for a block in a picture and decoding the picture, the decoding apparatus comprising:
a candidate list derivation circuit that derives an intra candidate list by storing one or more first prediction modes into the intra candidate list, and then adding a plurality of second prediction modes into the intra candidate list; and
a parameter decoding circuit that decodes a parameter for deriving an intra prediction mode from the intra candidate list,
wherein the candidate list derivation circuit adds the plurality of second prediction modes into the intra candidate list in an ascending order of distances from the first prediction modes.
